(19) United States
(12) Patent Application Publication
(10) Pub. No.: US 2016/0295423 A1
(43) Pub. Date: Oct. 6, 2016

(54) A Network Node, A Wireless Communication Device and Methods Therein for Handling Uplink Transmissions

(71) Applicant: TELEFONAKTIEBOLAGET LM ERICSSON (PUBL), Stockholm (SE)

(72) Inventor: Mattias Tan Bergström, Stockholm (SE)

(21) Appl. No.: 14/894,150

(22) PCT Filed: Oct. 16, 2015
(86) PCT No.: PCT/SE2015/051101

§ 371 Date: Nov. 25, 2015

Related U.S. Application Data
(60) Provisional application No. 62/076,532, filed on Nov. 7, 2014.

(51) Int. Cl. H04W 24/02; H04W 56/00; H04L 1/16; H04W 24/10; H04W 74/00

(52) U.S. Cl. CPC H04W 24/02; H04W 24/10; H04W 74/004; H04L 1/1614; H04W 56/0045; H04W 80/02

(57) ABSTRACT

A method performed by a wireless communication device for handling uplink transmission in a wireless communications network. The wireless communications network comprises one or more serving cells serving the wireless communication device. The wireless communications network further comprises at least a first network node associated with at least one serving cell out of the one or more serving cells.

The wireless communication device stops (602) uplink transmission in a first serving cell out of the one or more serving cells.

The wireless communication device further transmits (603) a report to the first network node. The report comprises a Medium Access Control, MAC, control element. The MAC control element indicates that the wireless communication device has stopped uplink transmission in at least one serving cell out of the one or more serving cells.

### TECHNICAL FIELD

Embodiments herein relate to a network node, a wireless communication device, and methods therein. In particular they relate to handling stopping an Uplink, UL transmission in a wireless communications network.

### BACKGROUND

Wireless communication devices such as terminals are also known as e.g. User Equipments (UE), mobile terminals, wireless terminals and/or mobile stations. These terms will be used interchangeably hereafter. Wireless communication devices are enabled to communicate wirelessly in a wireless or cellular communications network or a wireless communication system, sometimes also referred to as a cellular radio system or a cellular network. The communication may be performed e.g. between two wireless communication devices, between a wireless communication device and a regular telephone and/or between a wireless communication device and a server via a Radio Access Network (RAN) and possibly one or more core networks, comprised within the cellular communications network.

Examples of wireless communications networks are Long Term Evolution (LTE), Universal Mobile Telecommunications System (UMTS) and Global System for Mobile communications (GSM).

Wireless communication devices may further be referred to as mobile telephones, cellular telephones, laptops, or surf plates with wireless capability, just to mention some further examples. The wireless communication devices in the present context may be, for example, portable, pocket-storable, hand-held, computer-comprised, or vehicle-mounted mobile devices, enabled to communicate voice and/or data, via the RAN, with another entity, such as another wireless communication devices or a server.

The cellular communications network covers a geographical area which is divided into cell areas, wherein each cell area being served by an access node such as a base station, e.g. a Radio Base Station (RBS), which sometimes may be referred to as e.g. “eNB”, “eNodeB”, “NodeB”, “B node”, or BTS (Base Transceiver Station), depending on the technology and terminology used. The base stations may be of different classes such as e.g. macro eNodeB, home eNodeB or pico base station, based on transmission power and thereby also cell size. A cell is the geographical area where radio coverage is provided by the base station at a base station site. One base station, situated on the base station site, may serve one or several cells. Further, each base station may support one or several communication technologies. The base stations communicate over the air interface operating on radio frequencies with the terminals within range of the base stations. In the context of this disclosure, the expression Downlink (DL) is used for the transmission path from the base station to the wireless communication devices. The expression Uplink (UL) is used for the transmission path in the opposite direction i.e. from the wireless communication devices to the base station.

In 3rd Generation Partnership Project (3GPP) LTE, base stations, which may be referred to as eNodeBs or even eNBs, may be directly connected to one or more core networks and related core network nodes. 3GPP LTE radio access standard has been written in order to support high bitrates and low latency both for uplink and downlink traffic. All data transmission is in LTE controlled by the radio base station.

LTE Overview

LTE uses Orthogonal Frequency Division Multiplexing (OFDM) in the downlink and Discrete Fourier Transform (DFT)-spread OFDM in the uplink. The basic LTE downlink physical resource may thus be seen as a time-frequency grid as illustrated in FIG. 1, where each resource element corresponds to one OFDM subcarrier during one OFDM symbol interval.

In the time domain, LTE downlink transmissions are organized into radio frames of 10 ms, each radio frame having ten equally-sized subframes of length Tsubframe=1 ms.

Furthermore, the resource allocation in LTE is typically described in terms of Resource Blocks (RB), where a resource block corresponds to one timeslot (0.5 ms) in the time domain and 12 contiguous subcarriers in the frequency domain. A pair of two adjacent resource blocks in time direction (1.0 ms) is known as a resource block pair. Resource blocks are numbered in the frequency domain, starting with 0 from one end of the system bandwidth.

The notion of Virtual Resource Blocks (VRB) and Physical Resource Blocks (PRB) has been introduced in LTE. The actual resource allocation to a wireless communication device, such as a UE, can be made in terms of VRB pairs. There are two types of resource allocations, localized and distributed. In the localized resource allocation, a VRB pair is directly mapped to a PRB pair, hence two consecutive and localized VRB are also placed as consecutive PRBs in the frequency domain. On the other hand, the distributed VRBs are typically not mapped to consecutive PRBs in the frequency domain; thereby providing frequency diversity for data channel transmitted using these distributed VRBs.

Downlink transmissions may be dynamically scheduled, i.e., in each subframe the base station may transmit control information referring to which wireless communication devices, UEs or terminals some data is transmitted and upon which resource blocks the data is transmitted, in the current downlink subframe. This control signaling is typically transmitted in the first 1, 2, 3 or 4 OFDM symbols in each subframe and the number n=1, 2, 3 or 4 is known as the Control Format Indicator (CFI). The downlink subframe also contains common reference symbols (CRS), which are known to the receiver and used for coherent demodulation of e.g. the control information.

Carrier Aggregation

The LTE Release-10 (Rel-10) specifications have recently been standardized, supporting Component Carrier (CC) bandwidths up to 20 MHz which is the maximal LTE Release-8 (Rel-8) carrier bandwidth. Hence, an LTE Rel-10 operation wider than 20 MHz is possible and appear as a number of LTE carriers to an LTE Rel-10 capable terminal or UE.

In particular for early LTE Rel-10 deployments it may be expected that there will be a smaller number of LTE Rel-10-capable terminals compared to many LTE legacy terminals, i.e. terminals which are not LTE Rel-10-capable. Therefore, it may be helpful to assure an efficient use of a wide carrier also for legacy terminals, i.e. so that it is possible to implement carriers where legacy terminals may be scheduled in all parts of the wideband LTE Rel-10 carrier. A straightforward way to obtain this may be to employ Carrier Aggregation (CA). CA implies that an LTE Rel-10 terminal may receive multiple CCs, where the CCs have, or at least the possibility to have, the same structure as a Rel-8 carrier. CA is illustrated in FIG. 2.

The Rel-10 standard support up to 5 aggregated carriers where each carrier is limited in the RF specifications to have a one of six bandwidths namely 6, 15, 25, 50, 75 or 100 RB corresponding to 1.4, 3, 5, 10, 15 and 20 MHz, respectively.

The number of aggregated CCs as well as the bandwidth of each individual CC may be different for uplink and downlink. A symmetric configuration refers to the case where the number of CCs is the same in downlink and in uplink whereas an asymmetric configuration refers to the case that the number of CCs is different. It should be noted that the number of CCs configured in the network may be different from the number of CCs seen by a terminal: A terminal may for example support more downlink CCs than uplink CCs, even though the network offers the same number of uplink and downlink CCs.

CCs are also referred to as cells or serving cells. More specifically, in an LTE network the cells aggregated by a terminal are denoted Primary Serving Cell (PCell) and Secondary Serving Cells (SCells). The term serving cell may thus refer to both PCell and SCells. All wireless communication devices, such as UEs, have one PCell. Which cell is a UE's PCell is specific for the UE. Signaling which is considered to be “important”, i.e. vital control signaling and other important signaling, is typically handled via the PCell. Uplink control signaling is always sent on a UE's PCell. The component carrier configured as the PCell is the primary CC whereas all other component carriers are secondary serving cells.

Each SCell is configured for a UE with a SCellIndex, which is an identifier or so called Cell Index which is unique among all serving cells configured for this UE. The PCell typically has Cell Index 0 and an SCell may have an integer cell index of 1 to 7.

During initial access an LTE Rel-10 terminal behaves similar to an LTE Rel-8 terminal. Upon successful connection to the network a terminal may—depending on its own capabilities and the network—be configured with additional CCs in the UL and DL. Configuration is based on Radio Resource Control (RRC). Due to the heavy signaling and rather slow speed of RRC signaling it is envisioned that a terminal may be configured with multiple CCs even though all of them might not be currently used. If a terminal is activated on multiple CCs this may imply it has to monitor all DL CCs for Physical Downlink Control Channel (PDCCH) and Physical Downlink Shared Channel (PDSCH). This implies a wider receiver bandwidth, higher sampling rates, etc. resulting in high power consumption.

Timing Alignment

In order to preserve orthogonality in UL, the UL transmissions from multiple terminals or UEs need to be time aligned at the eNodeB. Since UEs may be located at different distances from the eNodeB as shown in FIG. 3, the UEs will need to initiate their UL transmissions at different times. A UE located far from the eNodeB needs to start transmission earlier than a UE located close to the eNodeB. This may for example be handled by time advance (TA), of the UL transmissions, a UE starts its UL transmission before a nominal time given by the timing of the DL signal received by the UE. This concept is illustrated in FIG. 4.

The UL timing advance is maintained by the eNodeB through timing alignment commands to the UE based on measurements on UL transmissions from that UE.

Through timing alignment commands, the UE is ordered to start its UL transmissions earlier or later. This applies to all UL transmissions except for random access preamble transmissions on PRACH, i.e. including transmissions on PUSCH, PUCCH, and SRS.

There is a strict relation between DL transmissions and the corresponding UL transmission. Examples of this are
the timing between a DL-SCH transmission on PDSCH to the HARQ ACK/NACK feedback transmitted in UL (either on PUCCH or PUSCH);
the timing between an UL grant transmission on PDCCH to the UL-SCH transmission on PUSCH.

By increasing the timing advance value for a UE, the UE processing time between the DL transmission and the corresponding UL transmission decreases. For this reason, an upper limit on the maximum timing advance has been defined by 3GPP in order to set a lower limit on the processing time available for a UE. Further details may be found in 3GPP TS 36.211 v12.6.0. For LTE, this value has been set to roughly 667 microseconds which corresponds to a cell range of 100 km. Note that the TA value compensates for the round trip delay.

In LTE Rel-10 there is only a single timing advance value per UE and all UL cells are assumed to have the same transmission timing. The reference point for the timing advance is the receive timing of the primary DL cell.

In LTE Release-11 (Rel-11) different serving cells used by the same UE may have different timing advance. The current assumption in 3GPP is that the serving cells sharing the same TA value (for example depending on the deployment) will be configured by the network to belong to a so called TA Group (TAG). It is further assumed that if at least one serving cell of the TA group is time aligned, all serving cells belonging to the same group may use this TA value. To obtain time alignment for an SCell belonging to a different TA group than the PCell, the current 3GPP assumption is that network initiated random access may be used to obtain initial TA for this SCell and for the TA group the SCell belongs to. The reference point for the timing advance is the downlink reception timing for one cell in a TA group.

### SUMMARY

As part of developing embodiments herein, a problem will first be identified and discussed. LTE will be used as an example of a wireless communications network in which the problem may arise.

A wireless communication device, such as a UE, may stop UL transmission on serving cells, e.g. due to TA limitations. Since the wireless communication device may do this autonomously, i.e. without any instructions from the wireless communications network, the network, e.g. a network node, may not be aware of this and hence the wireless communications network may e.g. waste radio resources by scheduling the wireless communication device even though the wireless communication device may not use the resources since the UL transmissions are blocked.

It is an object of embodiments herein to improve the performance of a wireless communications network.

According to a first aspect of embodiments herein it is provided a method performed by a wireless communication device for handling uplink transmission in a wireless communications network. The wireless communications network comprises one or more serving cells serving the wireless communication device. The wireless communications network further comprises at least a first network node associated with at least one serving cell out of the one or more serving cells.

The wireless communication device stops uplink transmission in a first serving cell out of the one or more serving cells.

The wireless communication device further transmits a report to the first network node. The report comprises a Medium Access Control, MAC, control element. The MAC control element indicates that the wireless communication device has stopped uplink transmission in at least one serving cell out of the one or more serving cells.

According to a second aspect of embodiments herein it is provided a method performed by a first network node for handling uplink transmission in a wireless communications network. The wireless communications network comprises one or more serving cells serving a wireless communication device. The wireless communications network further comprises at least the first network node associated with at least one serving cell out of the one or more serving cells.

The first network node receives a report from the wireless communication device. The report comprises a Medium Access Control, MAC, control element. The MAC control element indicates that the wireless communication device has stopped the uplink transmission in at least one serving cell out of the one or more serving cells.

The first network node determines which cell the wireless communication device has stopped the uplink transmission in based on the report.

According to a third aspect of embodiments herein it is provided a wireless communication device configured to operate in a wireless communications network. The wireless communication device is configured to perform the method according to the first aspect.

I.e. the wireless communication device is configured to handle uplink transmission in a wireless communications network. The wireless communications network comprises one or more serving cells serving the wireless communication device and further comprises at least a first network node associated with at least one serving cell out of the one or more serving cells.

The wireless communication device is configured to stop uplink transmission in a first serving cell out of the one or more serving cells.

The wireless communication device is further configured to transmit a report to the first network node in response to stopping uplink transmission in the first serving cell. The report comprises a Medium Access Control, MAC, control element. The MAC control element indicates that the wireless communication device has stopped uplink transmission in at least one serving cell out of the one or more serving cells.

According to a fourth aspect of embodiments herein it is provided a network node configured to operate in a wireless communications network. The network node is configured to perform the method according to the second aspect.

I.e. the first network node is configured to handle uplink transmission in the wireless communications network. The wireless communications network comprises one or more serving cells serving a wireless communication device. The wireless communications network further comprises at least the first network node. The first network node is configured to be associated with at least one serving cell out of the one or more serving cells.

The first network node is configured to receive a report from the wireless communication device. The report comprises a Medium Access Control, MAC, control element. The MAC control element indicates that the wireless communication device has stopped the uplink transmission in at least one serving cell out of the one or more serving cells.

The first network node is further configured to determine which cell the wireless communication device has stopped the uplink transmission in based on the report.

Since the wireless communication device transmits the report comprising the control element, such as the MAC control element, indicating that the wireless communication device has stopped the UL transmission in a cell or group of cells, an improved way of handling UL transmission in a wireless communications network is enabled.

E.g. the first network node is able to determine in which cell the wireless communication device has stopped the UL transmission, based on the report. Further, the first network node is able to avoid scheduling resources that the wireless communication device will not use anyway since the first network node is informed that the UL transmissions on those resources are blocked by the wireless communication device according to the report. Thus radio resources may be used more effectively instead of being wasted.

An advantage of embodiments herein is that the MAC control elements are quick and very resource efficient which means that less signalling overhead is needed, e.g. compared to RRC signalling.

In LTE Re1-8/9/10 the eNodeB and the UE use so called MAC Control Elements (CE) to exchange information such as buffer status reports, power headroom reports and others.

Another advantage of embodiments herein is that the control element may indicate the cell or the group of cells, e.g. the TAG(s), in which the wireless communication device has stopped UL transmission. This means that the network node may improve the determination of which cells or group of cells the wireless communication device has stopped transmitting, based on the control element.

Embodiments herein further allow the network node to take appropriate actions for the wireless communication device and the serving cells as a consequence of the report. The actions may be based on the report comprising the control element, such as the MAC CE, and may comprise deactivating serving cells for which the wireless communication device has stopped UL on, or de-configuring the UL part of those serving cells, or completely de-configuring, i.e. both UL and DL, of those serving cells and/or stop scheduling the wireless communication device, i.e. to refrain from providing the wireless communication device with UL grants/DL assignment.

In this way, radio resources in the wireless communications network may be saved instead of being wasted.

As mentioned above, In LTE Rel-10 additional bandwidth resources may be added or removed by configuring/deconfiguring additional serving cells, so called SCells. The configuration/deconfiguration of cells is signalled by the eNB and is performed with RRC signalling. To further improve power savings and resource utilization the concept of activation/deactivation was introduced for SCells. The eNB has the possibility to deactivate a serving cell of a UE, for example if the eNB has decided that the UE should not use that serving cell for the moment. Activation/deactivation may be performed with MAC signalling which is fast, e.g. compared to RRC signalling. The activation/deactivation procedure is described in detail in section 5.13 of 3GPP TS 36.321, V12.3.0.

One of the areas where MAC CEs are used is for activation and deactivation of SCells. The Rel-10 Activation/Deactivation MAC CE is defined in section 6.1.3.8 of 3gpp TS 36.321 V12.3.0. The Activation/Deactivation MAC CE comprises a single octet containing seven C-fields and one R-field. Each C-field corresponds to a specific SCellIndex and indicates whether the specific SCell is activated or deactivated. The UE will ignore all C-fields associated with Cell indices not being configured. The Activation/Deactivation MAC CE always indicates the activation status of all configured SCells, meaning that if the eNB wants to activate one SCell it has to include all configured SCells, setting them to activated or deactivated even if their status has not changed.

### BRIEF DESCRIPTION OF THE DRAWINGS

Examples of embodiments herein are described in more detail with reference to attached drawings in which:

FIG. 1 is a schematic block diagram illustrating a time-frequency grid.

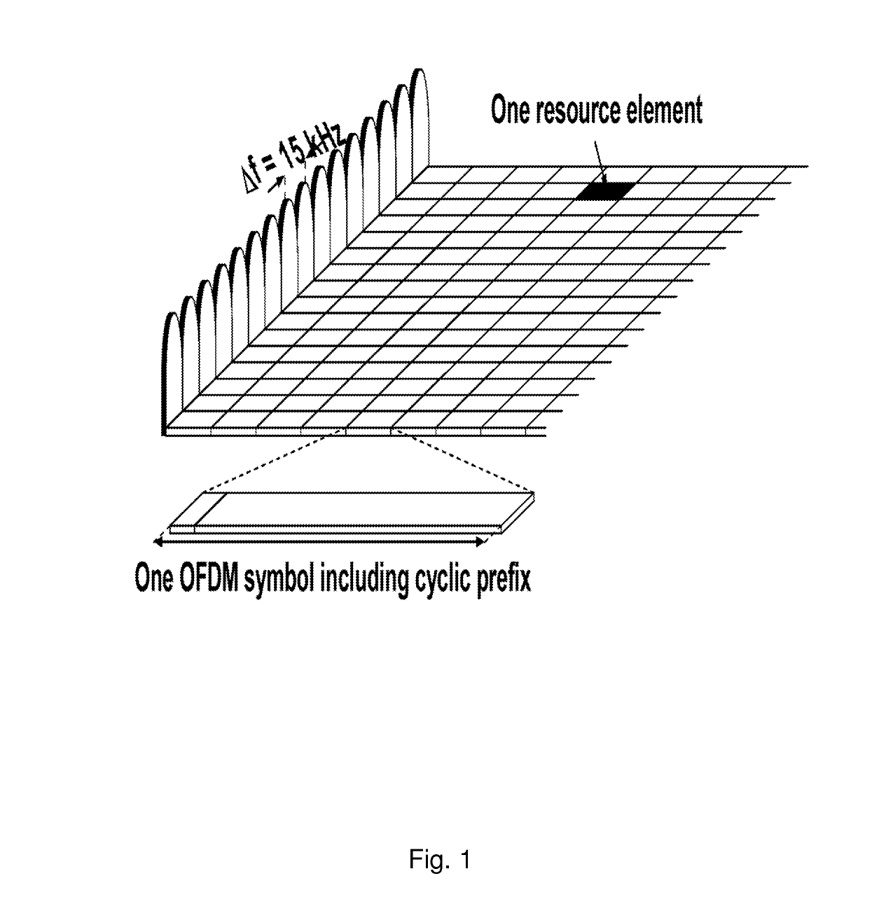

FIG. 2 is a schematic block diagram illustrating carrier aggregation.

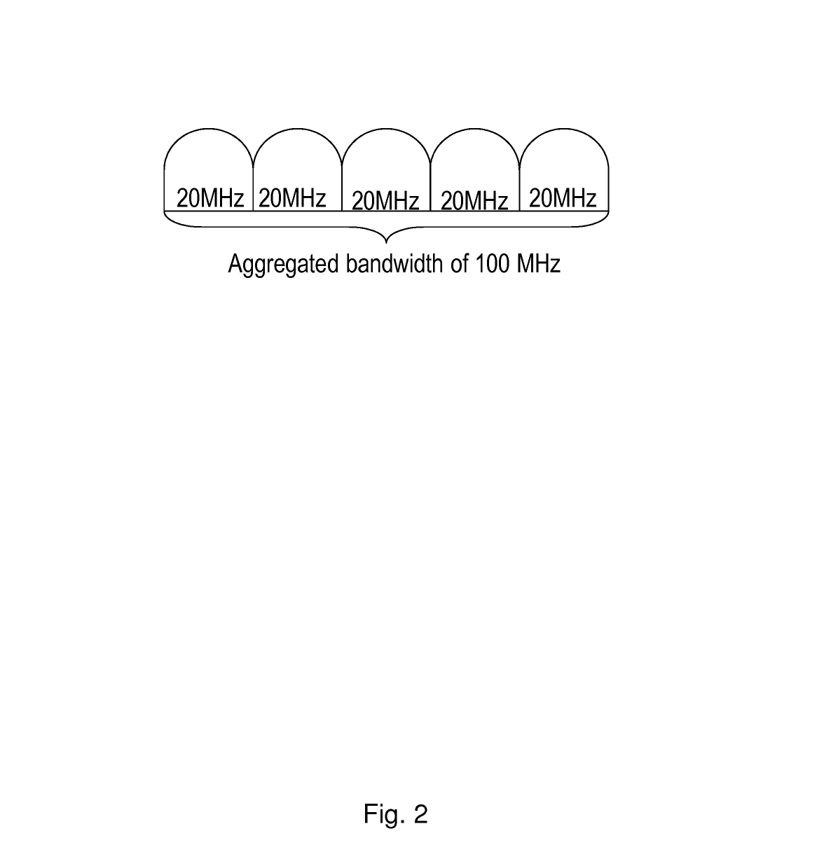

FIG. 3 is a schematic block diagram illustrating two UEs with different distances to an eNodeB.

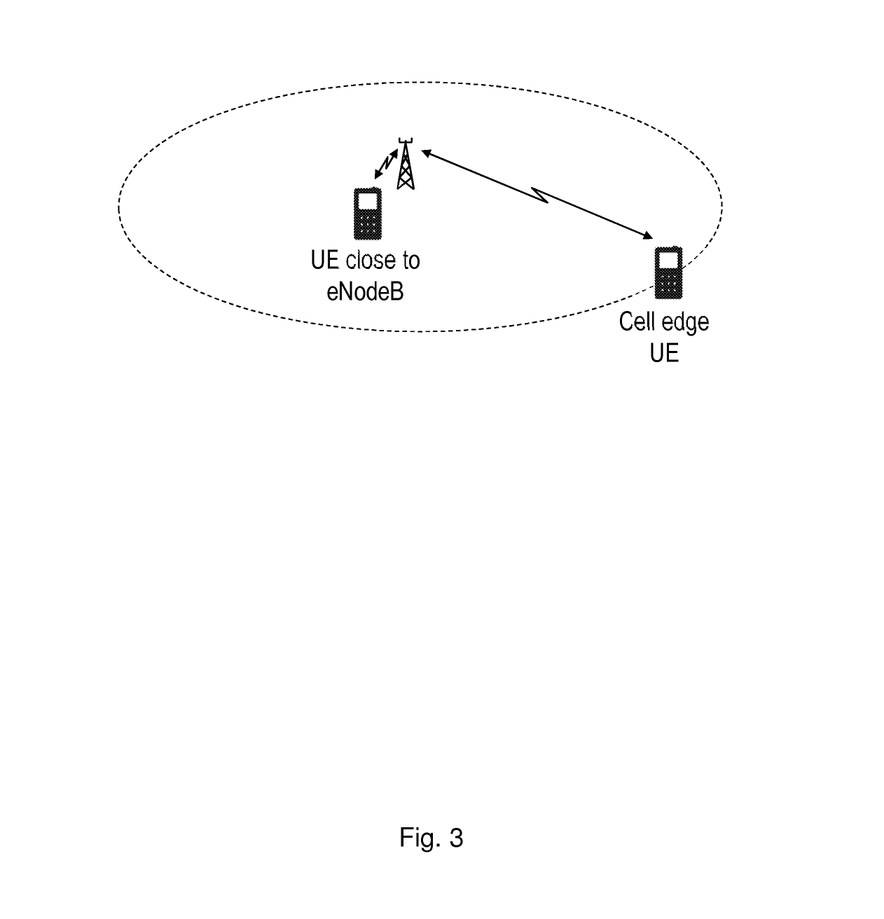

FIG. 4 is a schematic block diagram illustrating timing alignment between two UEs with different distances to an eNodeB.

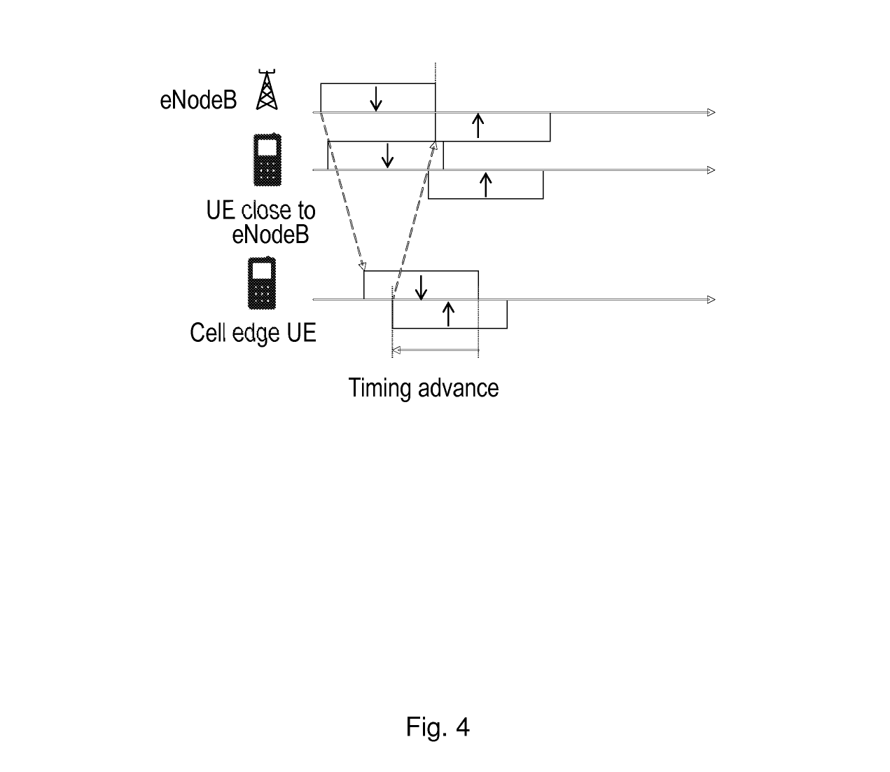

FIG. 5 is a schematic block diagram illustrating a wireless communications network.

FIG. 6 is a flowchart illustrating embodiments of a method performed by a wireless communication device.

FIG. 7 is a schematic block diagram illustrating embodiments of a wireless communication device.

FIG. 8 is a flowchart illustrating embodiments of a method performed by a network node.

FIG. 8b is a flowchart illustrating further embodiments of a method performed by a network node.

FIG. 9 is a schematic block diagram illustrating embodiments of a network node.

FIG. 10 is a schematic block diagram illustrating a MAC control element.

FIG. 11 is a schematic block diagram illustrating a further MAC control element.

FIG. 12 is a schematic block diagram illustrating yet a further MAC control element.

FIG. 13 is a schematic block diagram illustrating yet a further MAC control element.

### DETAILED DESCRIPTION

As mentioned above a wireless communication device, such as a UE, may stop UL transmission on serving cells, e.g. due to TA limitations. Since the wireless communication device may do this autonomously, i.e. without any instructions from the wireless communications network, the network, e.g. a network node, may not be aware of this and hence the wireless communications network may e.g. waste radio resources by scheduling the wireless communication device even though the wireless communication device may not use the resources since the UL transmissions are blocked.

Embodiments herein provide a way for a wireless communication device, such as a UE, to quickly inform the network, using MAC CEs, that the wireless communication device has stopped performing uplink transmissions on certain cells. Embodiments herein allow the network to take appropriate actions, such as deconfiguring and/or deactivating relevant serving cells and/or stop scheduling the wireless communication device on the relevant serving cells, etc.

Embodiments herein describe possible designs of reports used by a wireless communication device, a terminal, or a UE, the terms will be used interchangeably in this document, to indicate to a network node when the wireless communication device has stopped UL transmissions on cells.

It should be noted that in LTE the term “serving cell” refers to a cell which a terminal is configured to use. So if a terminal A is configured to use a Cell X then Cell X is a “serving cell” to terminal A, while if another terminal is not configured to use Cell X, then Cell X is not a “serving cell” to that other terminal. This means that for one terminal all cells which the terminal is configured to use are “serving cells” and unless otherwise indicated these terms will be used interchangeably herein.

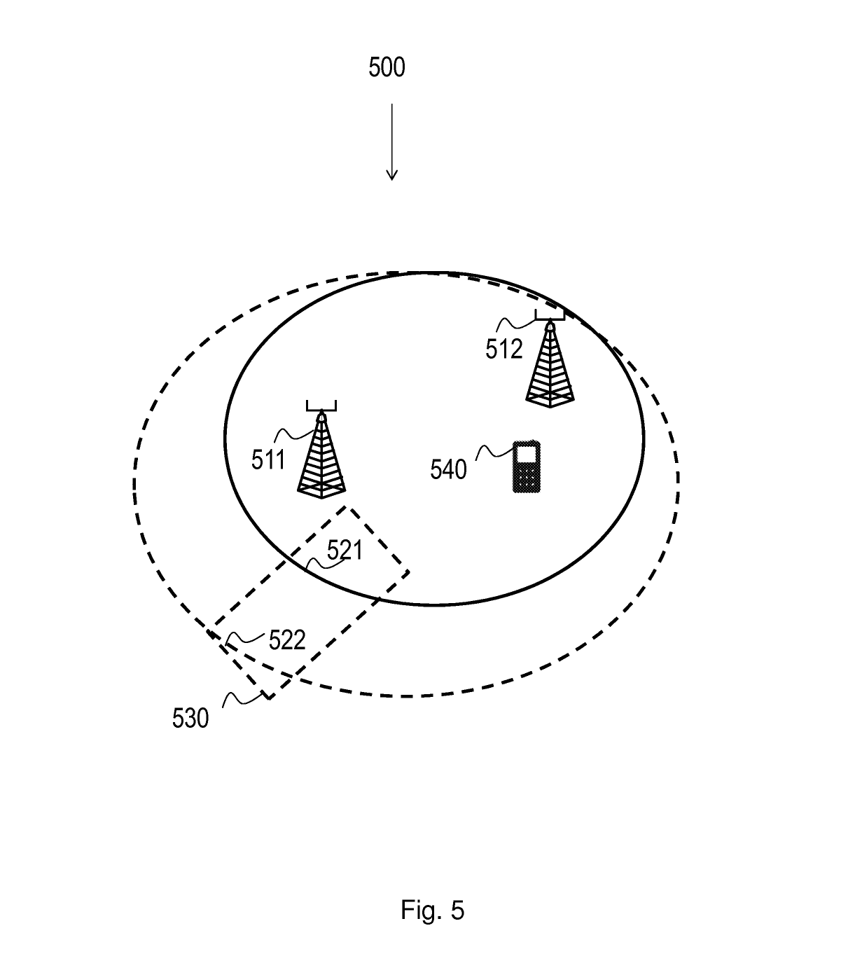

Embodiments herein may be implemented in one or more wireless communications networks and FIG. 5 depicts parts of such a wireless communications network 500. The wireless communications network 500 may for example be an LTE, UMTS, GSM, any 3GPP wireless communications network, or any cellular wireless communications network or system. LTE will hereafter be used to exemplify the embodiments although the solution is thus not limited thereto.

The wireless communications network 500 comprises a plurality of base stations and/or other network nodes. More specifically, the wireless communications network 500 comprises a first network node 511.

The term “network node” may correspond to any type of radio network node or any network node which communicates with at least a radio network node. For example, the first network node 511 may be a base station, such as an eNB. The base station may also be referred to as a NodeB, an evolved Node B (eNB, eNode B), a base transceiver station (BTS), Access Point (AP) Base Station, Wi-Fi AP, base station router, or any other network unit capable of communicating with a wireless communication device within a cell served by the base station depending e.g. on the radio access technology and terminology used.

The first network node 511 may also be an RNC in an UMTS system.

The wireless communications network 500 further comprises cells serving wireless communication devices. A cell is a geographical area where radio coverage is provided by network node equipment such as Wi-Fi AP equipment, base station equipment at a base station site or at remote locations in Remote Radio Units (RRU). The first network node 511 is an example of such network node equipment. The cell definition may also incorporate frequency bands and radio access technology used for transmissions, which means that two different cells may cover the same geographical area but using different frequency bands. Each cell is identified by an identity within the local radio area, which is broadcast in the cell. Another identity identifying cells uniquely in the whole of a wireless communication network is also broadcasted in the cells.

In dual connectivity (DC) a wireless communication device, such as UE, may be served by two network nodes called master eNB (MeNB) and secondary eNB (SeNB). The wireless communication device may e.g. be configured with PCC from both MeNB and SeNB. The PCell from MeNB is called PCell. The PCell from SeNB is called PSCell. Sometimes PSCell is referred to as Special SCell. The PCell and PSCell operate the wireless communication device typically independently. The wireless communication device is also configured with one or more SCCs from each of MeNB and SeNB. The corresponding secondary serving cells served by MeNB and SeNB are called SCell. The group of cells associated with the MeNB and SeNB is sometimes referred to as Master Cell Group (MCG) and Secondary Cell Group (SCG), respectively. The wireless communication device in DC typically has a separate transmitter/receiver pair (TX/RX) for each of the connections with MeNB and SeNB. This allows the MeNB and SeNB to independently configure the wireless communication device with one or more procedures e.g. Radio Link Monitoring (RLM), DRX cycle etc on their PCell and PSCell respectively.

In some embodiments herein the first network node 511 is a master eNB (MeNB) and in some embodiments the first network node 511 is a secondary eNB (SeNB).

In some embodiments where dual connectivity is used the wireless communications network 500 further comprises a second network node 512. In some embodiments the second network node 512 is a master eNB (MeNB) and in some embodiments the second network node 512 is a secondary eNB (SeNB). For example, if the first network node 511 is an MeNB in embodiments herein, then the second network node 512 may be an SeNB.

Network nodes, such as base stations and Wi-Fi AP, communicate over the air or radio interface operating on radio frequencies with wireless communication devices within range of the network nodes. The wireless communication devices transmit data over the radio interface to network nodes, such base stations and Wi-Fi AP, in UL transmissions, and network nodes, such as Wi-Fi AP and base stations, transmit data over an air or radio interface to the wireless communication devices in DL transmissions.

In embodiments herein the wireless communications network 500 comprises a cell 521 serving wireless communication devices, such as a wireless communication device 540, also referred to as a UE. The cell 521 thus is a serving cell for the wireless communication device 540. The cell 521 will hereafter alternatively be referred to as the first serving cell 521 to distinguish it from other cells. The first network node 511 may communicate with the wireless communication device 540. For example, the serving cell 521 may be associated with the first network node 511 and the first network node 511 may then communicate with the wireless communication device 540 via the serving cell 521. In some other embodiments the serving cell 521 is associated with another network node such as the second network node 512.

In some embodiments herein the cell 521 is a primary cell, PCell, and in some other embodiments herein the cell 521 is a secondary cell, SCell for the wireless communication device 540.

In some embodiments herein the wireless communications network 500 further comprises a second cell 522. The second cell 522 is a serving cell for the wireless communication device 540. The second cell 522 will hereafter alternatively be referred to as the second serving cell 522 to distinguish it from the first serving cell 521.

In some embodiments the second cell 522 is associated with the first network node 511, while in some other embodiments the second cell 522 is associated with the second network node 512. In other words, in some embodiments herein both the first cell 521 and the second cell 521 are associated with the first network node 511. In other embodiments herein one out of the first cell 521 and the second cell 522 is associated with the first network node 511, while the other cell is associated with the second network node 512.

In some embodiments herein the second cell 522 is a primary cell, PCell, and in some other embodiments herein the second cell 522 is a secondary cell, SCell for the wireless communication device 540.

In some embodiments herein the cell 521 and the second cell 522 form a group of cells 530, such as a TAG. The cell 521 and the second cell 522 may also belong to different groups of cells, such as different TAGs.

The wireless communication device 540 may further be e.g. a mobile terminal or a wireless terminal, a mobile phone, a computer such as e.g. a laptop, a Personal Digital Assistants (PDAs) or a tablet computer, sometimes referred to as a surf plate, with wireless capability, target device, device to device UE, MTC UE or UE capable of machine to machine communication, iPAD, mobile terminals, smart phone, Laptop Embedded Equipment (LEE), Laptop Mounted Equipment (LME), USB dongles etc. or any other radio network units capable to communicate over a radio link in a wireless communications network.

Please note the term user equipment used in this disclosure also covers other wireless devices such as Machine to machine (M2M) devices, even though they are not operated by any user.

Below, methods for handling a stopping of an UL transmission from the wireless communication device 540 in the cell 521 or in the group of cells 530 in the wireless communications network 500 will be illustrated in more detail by a number of exemplary embodiments. The following embodiments will be described using LTE as an example and the network node 511 will be an LTE base station, i.e. an eNB, although these embodiments are not limited to the use of LTE.

It should be noted that these embodiments are not mutually exclusive. Components from one embodiment may be tacitly assumed to be present in another embodiment and it will be obvious to a person skilled in the art how those components may be used in the other exemplary embodiments.

First, some embodiments will now be described from the perspective of the different nodes that participate. Then the interaction of the nodes will be described in detail for different scenarios.

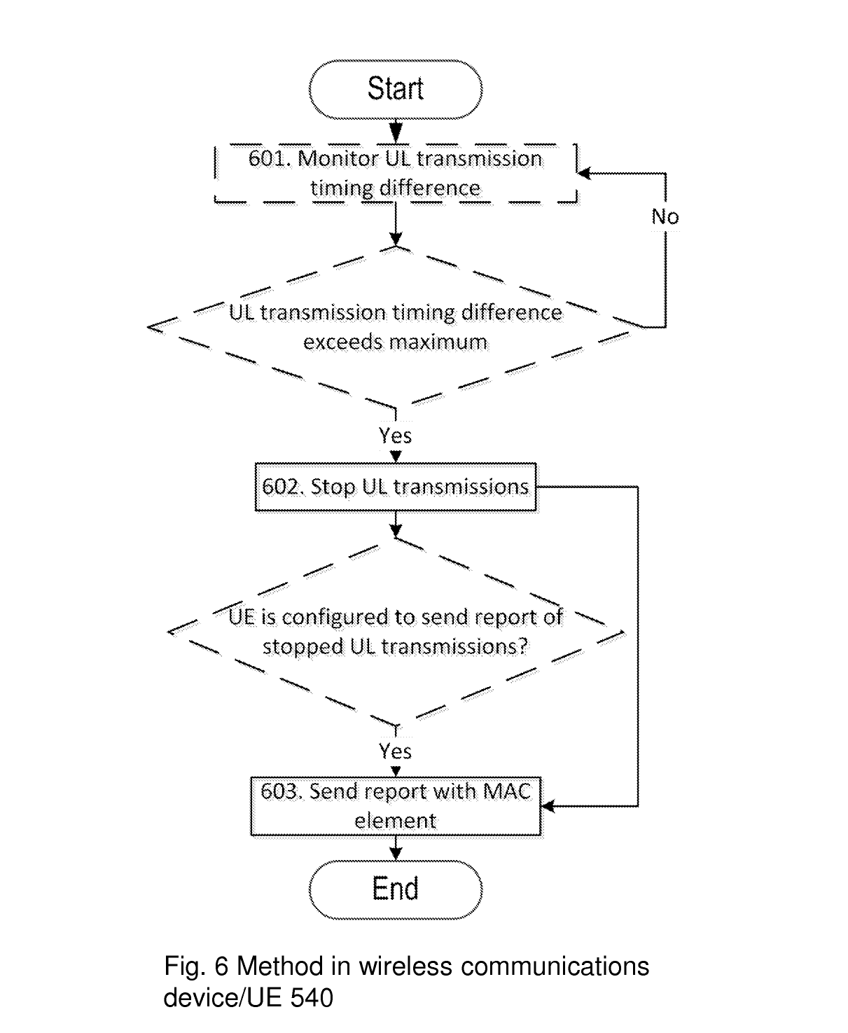

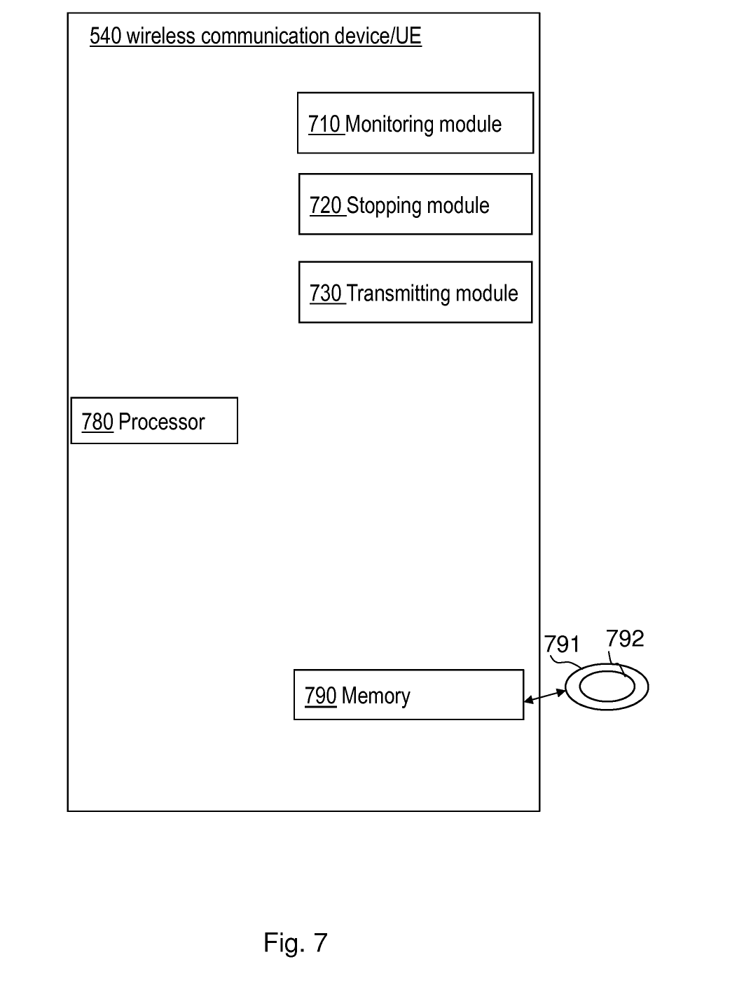

The following description refers to embodiments related to the wireless communication device 540. The wireless communication device 540 may be configured in accordance with embodiments described for FIGS. 6 and 7.

According to an aspect of embodiments herein it is provided a method in the wireless communication device 540 for handling UL transmission from the wireless communication device in the cell 521 or group of cells 530 in the wireless communications network 500.

An example of how the solution may be employed in terms of actions in a procedure performed by a wireless communication device for handling uplink transmission in a wireless communications network, will now be described with reference to the flow chart in FIG. 6 and with further reference to FIG. 5. The wireless communication device in this example thus corresponds to the wireless communication device 540 of FIG. 5.

As mentioned above, the wireless communications network 500 comprises the one or more serving cells 521, 522 serving the wireless communication device 540. The the wireless communications network 500 further comprises at least the first network node 511 associated with at least one serving cell 521, 522 out of the one or more serving cells 521, 522.

### Action 601

As mentioned above, since wireless devices may be located at different distances from a network node, such as an eNodeB, the wireless devices will need to initiate their UL transmissions at different times in order to be time aligned at the network node.

Therefore, in some embodiments herein the wireless communication device 540 monitors a timing difference for UL transmissions in the serving cell, cells or serving group of cells, such as a TAG. The serving group of cells may also be referred to as a group of serving cells. Further, there may be several groups of serving cells. For example the wireless communication device 540 may monitor a timing difference for UL transmissions in the first cell 521 or the group of cells 530.

This action may be performed by means such as a monitoring module 710 in the wireless communication device 540. The monitoring module 710 may be implemented by a processor 780 in the wireless communication device 540.

### Action 602

The wireless communication device 540 stops uplink transmission in the first serving cell 521 out of the one or more serving cells 521, 522.

For example, if the monitored timing difference is outside a prescribed limit, the wireless communication device 540 may stop the uplink transmissions due to limitations in handling this timing difference.

In other words, the wireless communication device 540 may stop an UL transmission, i.e. one or more transmissions, from the wireless communication device 540 in the serving cell, such as the first cell 521, or group of cells, such as the group of cells 530, if the UL transmission timing difference exceeds a value, such as a maximum allowable value.

This action may be performed by means of a stopping module 720 in the wireless communication device 540. The stopping module 720 may be implemented by the processor 780 in the wireless communication device 540.

### Action 603

The wireless communication device 540 transmits a report to the first network node 511. The report comprises a MAC control element 1001, 1101, 1201, 1301. The MAC control element 1001, 1101, 1201, 1301 indicates that the wireless communication device 540 has stopped uplink transmission in the first serving cell 521.

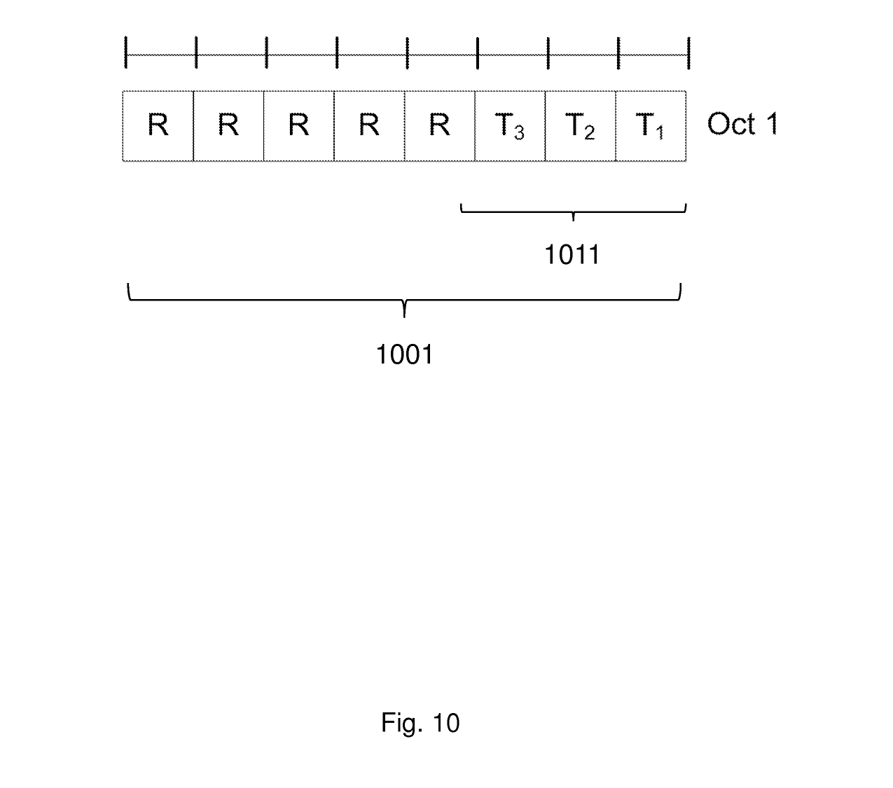

FIGS. 10-13 describe different embodiments of the MAC control element 1001, 1101, 1201, 1301.

In other words, the wireless communication device transmits a report to the first network node 511. The transmitted report to the first network node 511 may comprises a control element, such as a MAC control element indicating that the wireless communication device 540 has stopped the UL transmission in the serving cell 521 or the group of cells 530, e.g. the TAG.

In some embodiments, for example in a dual connectivity scenario, the wireless communication device 540 transmits the report to more than one network node, e.g. to both the MeNB and the SeNB. For example, the wireless communication device 540 may transmit the report to both the first network node 511 and the second network node 512. This may also be the case if the wireless communication device 540 has stopped transmitting in UL only in one of the cells, such as in the cell 521.

In some embodiments the wireless communication device 540 only sends this report to the eNB, for example the network node 511, which serves the cells 521 in which the wireless communication device 540 has stopped transmitting in UL. I.e. if the wireless communication device 540 stops transmitting in UL in a cell which belong to the MeNB, the wireless communication device may only send the report to the MeNB.

In some alternative embodiments the wireless communication device 540 only sends this report to an eNB, for example the second network node 512, which does not serve the cell which the wireless communication device has stopped transmitting in UL of.

The following embodiments are related to a dual connectivity scenario.

In some embodiments the wireless communication device 540 transmits the report to the first network node 511 and further transmits the report to the second network node 512 associated with at least one serving cell 521, 522 out of the one or more serving cells 521, 522. For example, the first network node 511 may be an MeNB and the second network node 512 may be an SeNB, or vice versa.

In another scenario the first network node 511 is associated with the first serving cell 521 in which the wireless communication device 540 has stopped uplink transmission in. Further, the second network node 512 is associated with at least one serving cell 522 serving the wireless communication device 540. Then in some embodiments the wireless communication device 540 transmits the report only to the first network node 511.

In some other scenarios the first serving cell 521 in which the wireless communication device 540 has stopped uplink transmission in is associated with the second network node 512. Then in some embodiments the wireless communication device 540 transmits the report to the first network node 511 only. For example, if there is no possibility to send uplink to the second network node 512 due to the stopping of the uplink transmissions in the first cell 521.

In some other embodiments, relating to the same scenario wherein the first serving cell 521 in which the wireless communication device 540 has stopped uplink transmission in is associated with the second network node 512, the wireless communication device 540 transmits the report to both the first network node 511 and the second network node 512.

The MAC control element may further indicate the first serving cell 521 in which the wireless communication device 540 has stopped uplink transmission in. When the first serving cell 521 is comprised in a group 530 of cells, then the MAC control element may further indicate the group 530 of cells in which the wireless communication device 540 has stopped uplink transmission in.

When the group 530 of cells is a TAG then the MAC control element 1001, 1101, 1201, 1301 indicates the TAG in which the wireless communication device 540 has stopped uplink transmission.

In some embodiments the first serving cell 521 in which the wireless communication device 540 has stopped uplink transmission in is indicated by a bitmap 1011 and wherein a field in the bitmap 1011 is mapped to the first serving cell 521 or to the group 530 of cells.

The field in the bitmap 1011 may be mapped to an index. The index corresponds to the first serving cell 521 or to the group 530 of cells. The mapping to the index is based on the position of the field in the bitmap 1011. For example, the report may contain a bitmap 1011 where each field in the bitmap 1011 is mapped to a cell or a TAG. It may be so that the order of the fields in the bitmap 1011 corresponds to the order of the cell indices or indices of the TAG. E.g. the Most Significant Bit (MSB) of the bitmap 1011 corresponds to the cell with the highest cell index while the Least Significant Bit (LSB) of the bitmap 1011 corresponds to the cell with the lowest cell index or vice versa. The size of the bitmap 1011 may be fixed. E.g. be fixed to have the size of the maximum supported indices. In some embodiments the size of the bitmap 1011 is dynamic and may depend on the number of cells and/or TAGs the wireless communication device is currently configured with.

In some embodiments two or more groups 1110, 1120 of fields are comprised in the bitmap 1011. Then a first group 1110 of field is associated with the first network node 511 and a second group 1120 of field is associated with the second network node 512.

The report may further indicate which network node 511, 512 that is associated with the first serving cell 521 and/or the group 530 of cells in which the wireless communication device 540 has stopped uplink transmission in.

As mentioned above, the report may further indicate the cell 521 or the group of cells 530, e.g. the TAGs, for which the wireless communication device 540 has stopped UL in. This means that the first network node 511 may improve the determination of which cells or group of cells the wireless communication device 540 has stopped transmitting in based on the control element 1001, 1101, 1201, 1301. For example, the first network node 511 may immediately determine which cell the wireless communication device 540 has stopped transmitting in based on the cell index indicated in the bitmap 1011.

However, in some embodiments the report is transmitted without cell or TAG indications in order to reduce signalling between the wireless communication device 540 and the first network node 511. Then the first network node 511 determines which cell or group of cells in which the wireless communication device 540 has stopped UL transmission based on the report and on some additional information. This will be explained further below when the interaction of the nodes is described in more detail.

The wireless communication device 540 may trigger transmitting the report upon or shortly before or after, e.g. in the same TTI or a few TTIs prior or after, stopping transmissions in at least one serving cell, such as in the cell 521. Whether the wireless communication device shall send the reports introduced herein may be configured by the network. The network, for example through the network node 511, may have indicated to the wireless communication device 540, e.g. using RRC signalling, whether the wireless communication device 540 shall transmit such a report.

The report may be transmitted with MAC signalling.

This action may be performed by a transmitting module 730 in the wireless communication device 540. The transmitting module 730 may be implemented by a transmitter in the wireless communication device 540.

Embodiments herein may be performed in the wireless communication device 540. The wireless communication device 540 may comprise the modules mentioned above and depicted in FIG. 7 for handling the UL transmission.

To perform the method actions for handling UL transmission from the wireless communication device 540 in the cell 521 or group of cells 530 in the wireless communications network 500 described above in relation to FIG. 6, the wireless communication device 540 comprises the following arrangement depicted in FIG. 7.

The wireless communication device 540 is configured to, e.g. by means of the stopping module 720 configured to, stop uplink transmission in a first serving cell 521 out of the one or more serving cells 521, 522.

The wireless communication device 540 is further configured to, e.g. by means of the transmitting module 730 configured to, transmit a report to the first network node 511 in response to stopping uplink transmission in the first serving cell 521. The report comprises the MAC control element 1001, 1101, 1201, 1301. The MAC control element 1001, 1101, 1201, 1301 indicates that the wireless communication device 540 has stopped uplink transmission in the first serving cell 521.

The MAC control element may further indicate the first serving cell 521 in which the wireless communication device 540 has stopped uplink transmission in. When the first serving cell 521 is comprised in a group 530 of cells, then the MAC control element may further indicate the group 530 of cells in which the wireless communication device 540 has stopped uplink transmission in.

In some embodiments the wireless communication device 540 is further configured to transmit the report to the second network node 512 associated with at least one serving cell 521, 522 out of the one or more serving cells 521, 522.

In some scenarios the second network node 512 is associated with at least one serving cell 521, 522 serving the wireless communication device 540, and the first network node 511 is associated with the first serving cell 521 in which the wireless communication device 540 has stopped uplink transmission in. Then the wireless communication device 540 may be configured to transmit the report only to the first network node 511.

The details of the report and other alternatives regarding to which network nodes the report is transmitted have been described above.

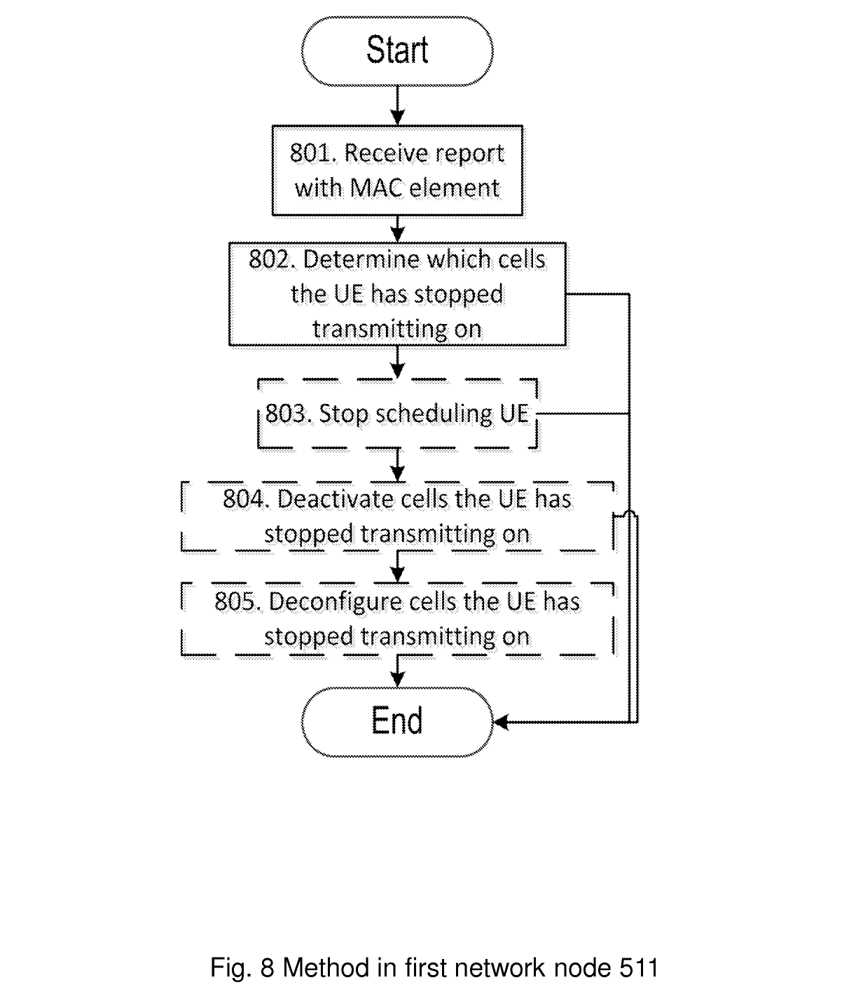

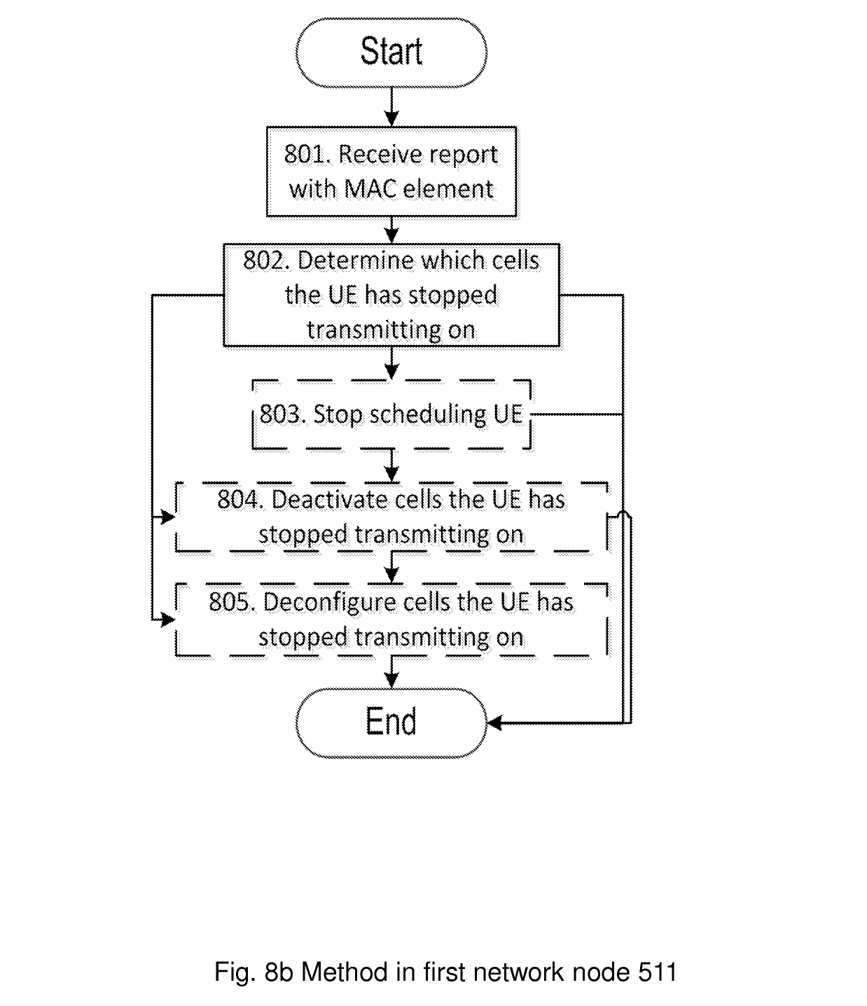

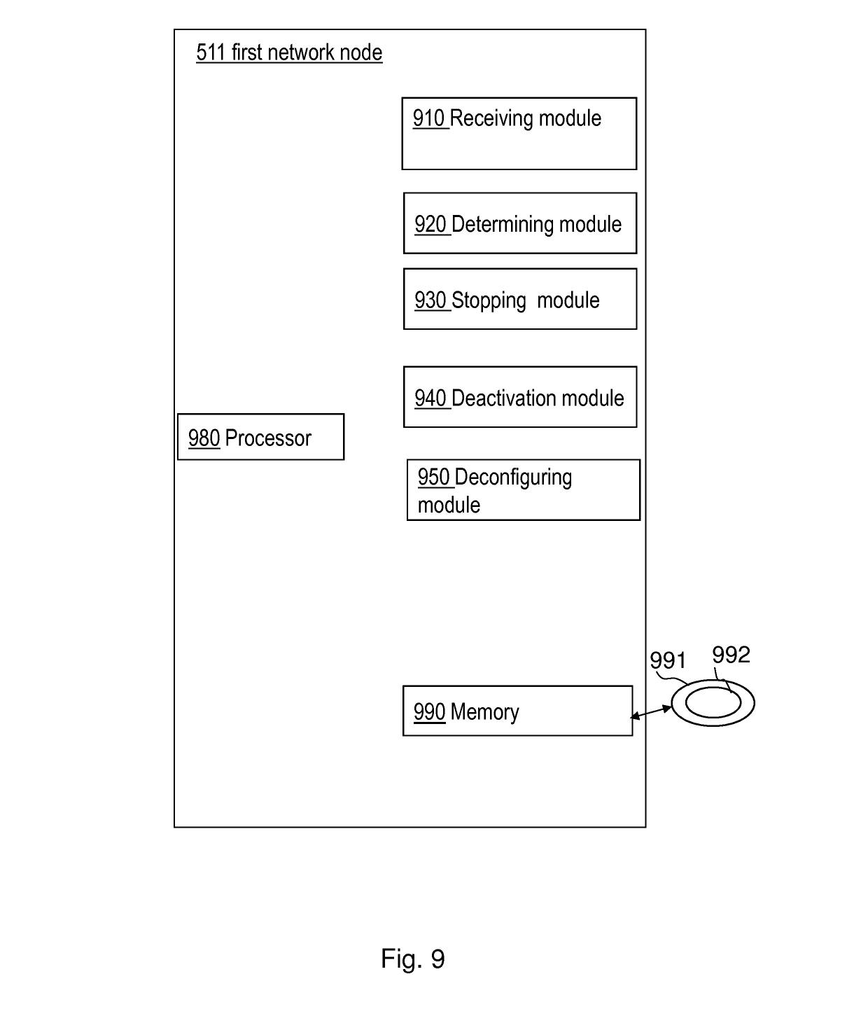

The followings are embodiments related to the network node 511. An example of how the solution may be employed in terms of actions in a procedure performed by a first network node for handling uplink transmission in a wireless communications network, will now be described with reference to the flow charts in FIGS. 8 and 8b, and with further reference to FIG. 5. The first network node in this example may thus correspond to the network node 511 of FIG. 5. The network node 511 embodiments relate to FIGS. 8, 8b and 9. FIG. 8b complements FIG. 8 by illustrating some more options regarding the flow of actions that may be performed by the first network node 511.

According to an aspect of embodiments herein it is provided a method in the first network node 511 for handling UL transmission from the wireless communication device 540 in the cell 521 or group of cells 530 in the wireless communications network 500.

### Action 801

The first network node 511 receives a report from the wireless communication device 540. The report comprises a MAC control element 1001, 1101, 1201, 1301. The MAC control element 1001, 1101, 1201, 1301 indicates that the wireless communication device 540 has stopped the uplink transmission in the first serving cell 521 out of the one or more serving cells 521, 522.

The MAC control element 1001, 1101, 1201, 1301 may further indicate the first serving cell 521 in which the wireless communication device 540 has stopped uplink transmission.

When the first serving cell 521 is comprised in a group 530 of cells, then the MAC control element 1001, 1102, 1201, 1301 may further indicate the group 530 of cells in which the wireless communication device 540 has stopped uplink transmission.

As mentioned above in relation to action 603 embodiments herein may be performed in a dual connectivity scenario. In some embodiments the first network node 511 is associated with the first serving cell 521 in which the wireless communication device 540 has stopped uplink transmission.

In some other embodiments the first serving cell 521 in which the wireless communication device 540 has stopped uplink transmission is associated with a second network node 512.

In other words, the first network node 511 receives a report from the wireless communication device 540, which report comprises a control element, such as a MAC control element, indicating that the wireless communication device 540 has stopped the UL transmission in a cell or a group of cells, e.g. a TAG. The report may further indicate the cell 521 or the group of cells 530, e.g. the TAGs, in which the wireless communication device 540 has stopped UL transmission.

Other details of the report have been described above in relation to action 603.

This action may be performed by means such as a receiving module 910 in the network node 511. The receiving module 910 may be implemented by a receiver in the network node 511.

This action is related to action 603 above.

### Action 802

The first network node 511 determines in which cell the wireless communication device 540 has stopped the uplink transmission, based on the report.

In some embodiments the determining is based on the received MAC control element 1001, 1101, 1201, 1301.

In this context a cell may be one or more cells, such as both the first cell 521 and the second cell 522, or the group 530 of cells. Thus the first network node 511 may determine in which cells or group of cells the wireless communication device 540 has stopped UL transmission based on the report.

The above determination may be based on the MAC control element comprising the indication. For example, the network node 511 may determine that the wireless communication device 540 has stopped UL transmission on the cell 521 or the group of cells 530. This means that the first network node 511 may improve the determination of in which cells or group of cells the wireless communication device 540 has stopped transmitting based on the control element 1001, 1101, 1201, 1301. For example, the first network node 511 may immediately determine in which cell the wireless communication device 540 has stopped transmitting based on the cell index indicated in the bitmap 1011.

In some other embodiments the wireless communication device 540, such as a UE, indicates that the wireless communication device 540 has stopped UL transmissions without indicating in which cells or which TAGs the UL transmissions has stopped. This allows for signaling reduction as the wireless communication device 540 does not need to indicate in which cells/TAGs the wireless communication device 540 has stopped transmissions.

The network, e.g. the network node 511, may know from this indication that the wireless communication device 540 has stopped UL transmission in at least one serving cell and/or TAG. However the network node 511 may need to have additional logic in order to determine in which serving cell the wireless communication device 540 has stopped uplink transmissions. One possibility is that the network node 511 determines this by determining in which cells and/or TAGs the network still receives UL transmissions from the wireless communication device 540.

The network node 511 may consider for example SRS transmissions when evaluating in which cells the terminal is still transmitting. SRS is, if configured, signaled periodically and hence the network node 511 will eventually, i.e. at latest after one SRS-period, know in which cells the wireless communication device 540 still transmits the SRS.

In another example the wireless communication device 540 is configured with three cells, Cell A, Cell B and Cell C. If the wireless communication device 540 stops transmitting in uplink on Cell B and therefore sends the report to the network node 511, while the network node 511 still receives UL transmissions from the wireless communication device 540 in Cell A and Cell C, then the network node 511 may determine that the wireless communication device 540 has stopped UL transmissions in Cell B.

In case the wireless communication device 540 is only allowed to autonomously stop uplink transmissions in certain cells, e.g. in all serving cells except the PCell and PSCell(s), then the network node 511 may also consider this when determining in which cells the wireless communication device 540 has stopped transmitting. For example, in the example above if Cell A is the PCell and the wireless communication device 540 is not allowed to autonomously stop transmissions in the PCell, then the network will determine that the wireless communication device 540 have not autonomously stopped uplink transmissions in Cell A.

This action may be performed by means of a determining module 920 in the network node 511. The determining module 920 may be implemented by a processor 980 in the network node 511.

In response to determining in which cells or group of cells the wireless communication device 540 has stopped UL transmission, the network node 511 may in one or other way limit the resources available for the wireless communication device 540 in the cell or group of cells where the wireless communication device 540 has stopped UL transmission.

In other words, in some embodiments the first network node 511 limits the resources available for the wireless communication device 540 in the first serving cell 521 in which the wireless communication device 540 has stopped uplink transmission, in response to determining 802 in which cell the wireless communication device 540 has stopped uplink transmission.

In the context of embodiments herein resources are for example radio resources and process resources. Process resources are resources for processing within a network node.

The network node 511 may for example perform any one or more out of actions 803-805, i.e. limiting may comprise any one or more out of these actions.

### Action 803

In some embodiments the network node 511 stops scheduling the wireless communication device 540 in the first serving cell 521 in which the wireless communication device 540 has stopped the uplink transmission. This is done in response to determining 802 which cell the wireless communication device 540 has stopped uplink transmission in.

In other words, in these embodiments the network node 511 stops a scheduling of the wireless communication device 540 in the cells or group of cells where the wireless communication device 540 has stopped UL transmission.

This action may be performed by means of a stopping module 930 in the network node 511. The stopping module 930 may be implemented by the processor 980 in the network node 511.

### Action 804

In some other embodiments the network node 511 deactivates the first serving cell 521 in which the wireless communication device 540 has stopped uplink transmission.

In other words, in these embodiments the network node 511 deactivates the serving cells, such as the cell 521, or group of cells 530 in which the wireless communication device 540 has stopped UL.

The deactivation may be implemented by MAC signalling to the wireless communication device 540.

This action may be performed by means such as a deactivation module 940 in the network node 511. The deactivation module 940 may be implemented by the processor 980 in the network node 511.

### Action 805

In some other embodiments the network node 511 de-configures any one or more out of the uplink part of the first serving cell 521 in which the wireless communication device 540 has stopped uplink transmission, and the downlink part of the first serving cell 521 in which the wireless communication device 540 has stopped uplink transmission.

In other words, in these embodiments the network node 511 deconfigures any one or more of the UL part and the DL part of the serving cells, such as the cell 521.

The de-configuring may be implemented by RRC signalling to the wireless communication device 540. This action may be performed by means such as a deconfiguring module 950 in the network node 511. The deconfiguring module 950 may be implemented by the processor 980 in the network node 511.

Embodiments herein may be performed in the network node 511. The network node 511 may comprise the modules mentioned above and depicted in FIG. 9 for handling the UL transmission.

To perform the method actions for handling UL transmission from the wireless communication device 540 in the cell 521 or group of cells 530 in the wireless communications network 500 described above in relation to FIG. 6, the first network node 511 comprises the following arrangement depicted in FIG. 9.

As mentioned above, the first network node 511 may be configured to serve the first serving cell 521 in which the wireless communication device 540 has stopped uplink transmission.

The network node 511 is configured to, e.g. by means of the receiving module 910 configured to, receive a report from the wireless communication device 540. The report comprises the MAC control element 1001, 1101, 1201, 1301. The MAC control element 1001, 1101, 1201, 1301 indicates that the wireless communication device 540 has stopped the uplink transmission in a first serving cell 521 out of the one or more serving cells 521, 522.

The details of the report have been described above in relation to action 603.

The network node 511 is further configured to, e.g. by means of the determining module 920 configured to, determine in which cell the wireless communication device 540 has stopped the uplink transmission based on the report.

When the MAC control element further indicates the first serving cell 521 in which the wireless communication device 540 has stopped uplink transmission, or the group 530 of cells in which the wireless communication device 540 has stopped uplink transmission, then the network node 511 is further configured to determine in which cell the wireless communication device 540 has stopped the uplink transmission based on the MAC control element.

The network node 511 may further be configured to limit the resources available for the wireless communication device 540 in the first serving cell 521 in which the wireless communication device 540 has stopped uplink transmission, in response to having determined in which cell the wireless communication device 540 has stopped uplink transmission.

In some embodiments the network node 511 is configured to limit the resources available for the wireless communication device 540 in the first serving cell 521 by being configured to, e.g. by means of the stopping module 930 configured to, stop scheduling the wireless communication device 540 in the first serving cell 521 in which the wireless communication device 540 has stopped the uplink transmission.

In some other embodiments the network node 511 is configured to limit the resources available for the wireless communication device 540 in the first serving cell 521 by being configured to, e.g. by means of the deactivating module 940 configured to, deactivate the first serving cell 521 in which the wireless communication device 540 has stopped uplink transmission.

In yet some other embodiments the network node 511 is configured to, e.g. by means of the stopping module 930 configured to limit the resources available for the wireless communication device 540 in the first serving cell 521 by being configured to, de-configure any one or more out of the uplink part of the first serving cell 521 in which the wireless communication device 540 has stopped uplink transmission, and the downlink part of the first serving cell 521 in which the wireless communication device 540 has stopped uplink transmission.

Some embodiments will now be described in more detail. LTE will be used to exemplify the embodiments. The wireless communications device 540 will be exemplified with a UE 540 in these embodiments.

Indication of Stopped Transmissions on TAGs

In one embodiment the UE 540, sends a report to the network node 511 indicating for which TA group or TA groups, such as TAGs, the UE 540 has stopped UL transmissions in. This implies that the UE 540 has stopped uplink transmissions in all serving cells associated with the indicated TA group(s).

The report may contain a bitmap 1011 where each field in the bitmap 1011 is mapped to one TAG. The mapping between the fields in the bitmap 1011 and the indices of the TAGs may be based on the position in the bitmap 1011, e.g. the LSB corresponds to the TAG with the lowest index, the next bit corresponds to the TAG with the second lowest index, and so on until the MSB which corresponds to the TAG with the highest index.

The UE 540 may in case the UE 540 has stopped UL transmissions on the cells in a certain TAG set the field in the bitmap 1011 which corresponds to the TAG to a certain value, e.g. “1” (or “0”), and set the value to “0” (or “1”) otherwise.

The size of the bitmap 1011 may be fixed. E.g. be fixed to have the size of the maximum supported TAG indices. For example in LTE it is currently supported to have 4 TAG indices and hence the bitmap 1011 size may then be 4 bits. In this case the UE 540 may assign a default value in the fields which correspond to TAGs which are not configured, e.g. assign the default value 0.

It should be noted that in case of Dual Connectivity the UE 540 supports two sets of TAGs, one set of TAGs associated with the MeNB and one set of TAGs associated with the SeNB. The same range of indices is used in the different sets of TAGs, i.e. there may be one TAG in the set associated with the MeNB which has the same index as a TAG in the set associated with the SeNB.

It may be possible that the size of the bitmap 1011 is dynamic and depends on the number of TAGs the UE 540 is currently configured. For example if the UE 540 is configured with 3 TAGs the size of the bitmap 1011 may be three where each field in the bitmap 1011 corresponds to a configured TAG. This may allow for some signaling reduction as a small bitmap 1011 may be used in case only a few TAGs are configured, while a larger bitmap 1011 is used when the UE 540 is configured with more TAGs.

In case the UE 540 is configured to only be allowed to stop transmissions in certain TAGs it may be possible to exclude indications for those TAGs which are not allowed to stop in and hence save some signaling. For example, if the UE 540 is configured to not stop transmissions on the TAG containing the PCell it may be possible to only include indications related to TAGs not containing the PCell in the report. This may enable some signaling reductions as no field corresponding to the TAG containing the PCell is included.

An example implementation of these embodiments is provided below in sections “Uplink Transmission Stop Reporting for TA groups”, “Uplink Transmission Stop Report MAC Control Element for TA groups” and Table 1, where a fixed size bitmap 1011 is used and the UE 540 is assumed to be not allowed to stop uplink transmissions on the TAG with index 0. The bitmap 1011 is shown in FIG. 10.

Index 0 in LTE corresponds to the TAG with the PCell. In the provided example implementation, if the UE 540 is configured with three TAGs—TAG 3, TAG 1 and TAG 0—and the UE 540 stops UL transmissions in e.g. TAG 1 the UE 540 may trigger and send an Uplink Transmission Stop Report MAC Control Element where e.g.:
T1 is set to 1 because the UE 540 has stopped UL transmissions in TAG 1
T2 is set to 0 because the UE 540 is not configured with a TAG 2
T3 is set to 0 because the UE 540 has not stopped UL transmissions in TAG 3
R-fields are all set to 0.

The UE 540 does not provide any information on TAG 0 because the UE 540 is assumed to be not allowed to stop uplink transmissions on the TAG with index 0.

Uplink Transmission Stop Reporting for TA groups

In some embodiments the TAG with index 0 is the TAG with the PCell. Further, the

UE 540 is not allowed to autonomously stop this TAG. Other TAGs which do not comprise the PCell are allowed to be stopped by the UE 540 and these TAGs are referred to as “sTAGs” herein. In these embodiments, the Uplink Stop Reporting procedure is used to indicate to the serving eNB, such as the first network node 511 and/or the second network node 512, that the UE 540 has stopped uplink transmissions in a secondary TAG (sTAG). If the UE 540 is configured with one or more sTAGs the UE 540 may stop uplink transmissions in SCells due to reaching the maximum uplink transmission timing difference as described in 3gpp TS 36.133 V12.5.0. The UE 540 shall report to the network, such as to the first network node 511 and/or the second network node 512, when the UE 540 stops uplink transmissions by sending the Uplink Transmission Stop Report MAC control element described below. In a TTI that the UE 540 stops uplink transmissions in at least one sTAG the UE 540 shall generate and transmit an Uplink Transmission Stop Reporting MAC control element as defined below. E.g. the UE 540 may instruct a Multiplexing and Assembly procedure in the UE 540 to generate and transmit the Uplink Transmission Stop Reporting MAC control element.

Uplink Transmission Stop Report MAC Control Element for TA groups

The Uplink Transmission Stop Report MAC control element is identified by a MAC Packet Data Unit (PDU) subheader with Logical Channel Indicator (LCID) as specified in Table 1. It has a fixed size with a single octet containing three T-fields and five R-fields.

The Uplink Transmission Stop Report MAC control element is defined as follows and with reference to FIG. 10.
Tᵢ: if there is a Secondary Timing Advance Group configured with stag-Id i as specified in 3gpp TS 36.331 V12.3.0, this field indicates whether the UE 540 has stopped uplink transmission on the serving cell(s) in the Secondary Timing Advance Group with stag-Id i, else the UE 540 shall set the Tᵢ field to “0”. The Tᵢ field is set to “1” to indicate that the UE 540 has stopped uplink transmissions in Secondary Timing Advance Group with stag-Id i. The Tᵢ field is set to “0” to indicate that the UE 540 has not stopped uplink transmissions in Secondary Timing Advance Group with stag-Id i;
R: Reserved bit, set to “0”.

TABLE 1
Values of LCID for UL-SCH

| Index | LCID values |
|---|---|
| 00000 | CCCH |
| 00001-01010 | Identity of the logical channel |
| 01011-10111 | Reserved |
| 11000 | Uplink Transmission Stop |
| | Report |
| 11001 | Extended Power Headroom |
| | Report |
| 11010 | Power Headroom Report |
| 11011 | C-RNTI |
| 11100 | Truncated BSR |
| 11101 | Short BSR |
| 11110 | Long BSR |
| 11111 | Padding |

Dual Connectivity Scenario

In case of Dual Connectivity it may be beneficial that the UE 540 indicates to the MeNB or SeNB that the UE 540 has stopped UL transmissions in a TAG belonging to the SeNB or MeNB.

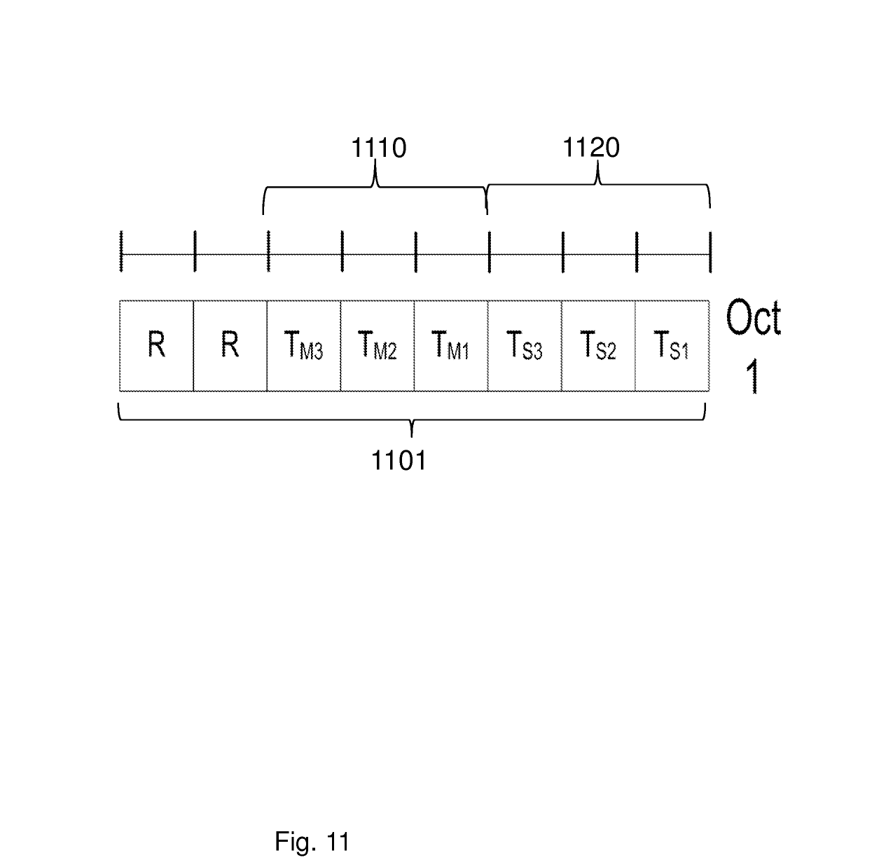

In one embodiment the UE 540 includes two groups 1110, 1120 of indications in the report, one group 1110 of fields associated with the MeNB, such as the first network node 511, and another group 1120 of fields associated with the SeNB, such as the second network node 512. One such MAC control element design is shown in FIG. 11. In this example there are three fields TM3, TM2 and TM1 associated to the TAGs associated to the MeNB/MCG and three fields TS3, TS2 and TS1 associated to the SeNB/SCG. The logic provided above for setting the fields may be applied also in this embodiment.

If for example the UE 540 may stop UL transmissions in TAG 2 of the MeNB, such as the first network node 511, then the UE 540 may report 00010000, and if it happened so that UL transmissions in both TAG 3 of the SeNB/SCG and TAG 1 of the MeNB/MCG was stopped the UE 540 may report 00001100.

In one embodiment the UE 540 indicates in one report only TAGs relevant to one eNB/CG, but then indicates with a flag 1202 which eNB/CG the report is relevant for. The UE 540 may then include the flag 1202 which is set to one value, e.g. “0”, or “1”, if the report is indicating which MeNB/MCG TAGs the UE 540 has stopped UL transmissions in. The flag 1202 may be set to another value, e.g. “1”, or “0”, if the report is indicating which SeNB/SCG TAGs the UE 540 has stopped UL transmissions in.

The receiving eNB, such as the first network node 511, may then know if the indicated TAGs are the TAGs of the MeNB/MCG or the SeNB/SCG, based on the CG id, i.e. the identity or index of the CG.

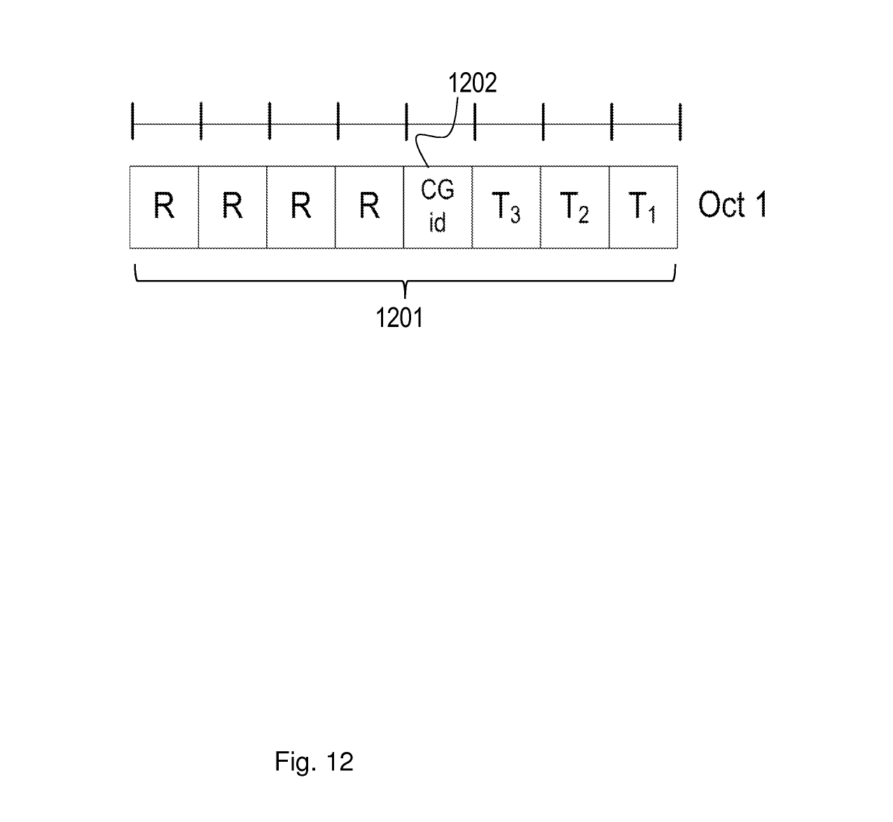

An example where a CG id indication is used is shown in FIG. 12.

In one embodiment the UE 540 sends the report to both eNBs, such as both the first network node 511 and the second network node 512, in a dual connectivity scenario. I.e. the UE 540 sends the report to both the MeNB and SeNB even if the UE 540 only stopped UL transmissions on cells associated with the SeNB or only to the MeNB.

Indication of Stopped Transmissions on Serving Cells

In some other embodiments the UE 540 indicates in which serving cell(s) the UE 540 has stopped transmitting. The UE 540 may indicate this by sending a bitmap 1311 where each entry in the bitmap 1311 corresponds to one cell. It may be so that the order of the fields in the bitmap 1311 corresponds to the order of the cell indices, e.g. the MSB of the bitmap 1311 corresponds to the cell with the highest cell index while the LSB of the bitmap 1311 corresponds to the cell with the lowest cell index or vice versa. The UE 540 may only provide indication for certain types of serving cells, e.g. only for SCells but not for the PCell or PSCell(s). In this case it may be possible to save some signaling.

An example implementation of this embodiment is provided below in sections “Uplink Transmission Stop Reporting for serving cells”, “Uplink Transmission Stop Report MAC Control Element for serving cells” and Table 2.

### Uplink Transmission Stop Reporting for Serving Cells

In the above-mentioned other embodiments the Uplink Stop Reporting procedure is used to indicate the serving eNB, such as the first network node 511, that the UE 540 has stopped uplink transmissions in an SCell. If the UE 540 is configured with one or more SCells the UE 540 may stop uplink transmissions in SCells due to reaching the maximum uplink transmission timing difference as described in 3gpp TS 36.133 V12.5.0. The UE 540 shall report to the network when the UE 540 stops uplink transmissions by sending the Uplink Transmission Stop Report MAC control element described below. In a TTI that the UE 540 stops uplink transmissions in at least one SCell the UE 540 shall instruct the Multiplexing and Assembly procedure to generate and transmit an Uplink Transmission Stop Reporting MAC control element as defined below.

Uplink Transmission Stop Report MAC Control Element for Serving Cells

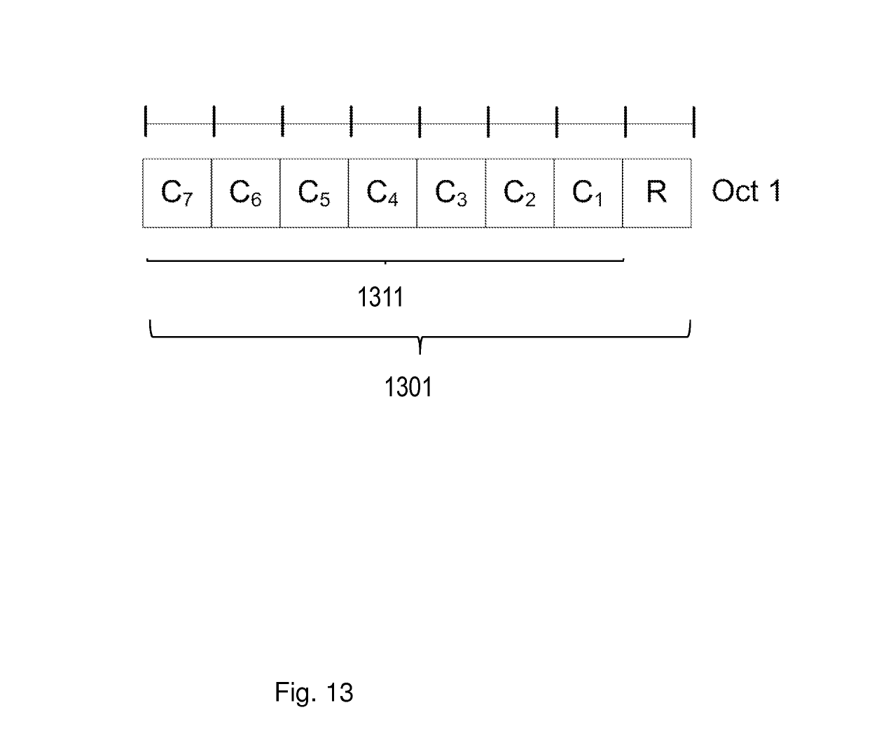

The Uplink Transmission Stop Report MAC control element is identified by a MAC PDU subheader with LCID as specified in Table 2. It has a fixed size with a single octet containing three T-fields and five R-fields. The Uplink Transmission Stop Report MAC control element is defined below and depicted in FIG. 13.
Cᵢ: if there is an SCell configured with SCellIndex i as specified in 3gpp TS 36.331 V12.3.0, this field indicates whether the UE 540 has stopped uplink transmission on the SCell with SCellIndex i, else the UE 540 shall set the Cᵢ field to “0”. The Cᵢ field is set to “1” to indicate that the UE 540 has stopped uplink transmissions in SCell with SCellIndex i. The Cᵢ field is set to “0” to indicate that the UE 540 has not stopped uplink transmissions in SCell with SCellIndex i;
R: Reserved bit, set to “0”.

TABLE 2
Values of LCID for UL-SCH

| Index | LCID values |
|---|---|
| 00000 | CCCH |
| 00001-01010 | Identity of the logical channel |
| 01011-10111 | Reserved |
| 11000 | Uplink Transmission Stop |
| | Report |
| 11001 | Extended Power Headroom |
| | Report |
| 11010 | Power Headroom Report |
| 11011 | C-RNTI |
| 11100 | Truncated BSR |
| 11101 | Short BSR |
| 11110 | Long BSR |
| 11111 | Padding |

Dual Connectivity Scenario for Serving Cells

In one alternative of the above-mentioned other embodiments the UE 540 sends the report to both eNBs in a dual connectivity scenario. I.e. the UE 540 sends the report to both the MeNB, such as the first network node 511, and SeNB, such as the second network node 512, even if the UE 540 only stopped UL transmissions on cells associated with the SeNB or only to the MeNB. This provides more information to the network, e.g. to the first network node 511, which may be useful in some scenarios. E.g. if the UL transmissions has been stopped due to that the MeNB and SeNB timing differs a lot then it may be relevant for both the MeNB and SeNB to be informed that the current UE 540 configuration was exceeding the supported maximum UL transmission timing difference for the UE 540. This may be useful for example if the network, such as the first network node 511, is using the information to build up some long-term statistics over which configurations are suitable in the network.

In one alternative of this embodiment the UE 540 only sends this report to the eNB which serves the cells in which the UE 540 has stopped transmitting in UL. I.e. if the UE 540 stops transmitting in UL in a cell 521 which belong to the MeNB, the UE 540 may only send the report to the MeNB, such as the first network node 511. This has the benefit that only the eNB which serves the cells in which the UE 540 has stopped UL transmissions is informed and hence some signaling may be saved. This alternative provides the network with less information. However, this may be acceptable in case the network only uses the report to for example determine when to stop scheduling the UE 540.

Whether the UE 540 shall report to both eNBs or only to the eNB which serves the cells in which the UE 540 has stopped transmitting in UL, may be configured by the network, e.g. by the first network node 511 and/or by the second network node 512.

The embodiments herein may be implemented through one or more processors, such as the processor 780 in the wireless communication device 540 depicted in FIG. 7, and the processor 980 in the network node 511 depicted in FIG. 9 together with computer program code for performing the functions and actions of the embodiments herein. The program code mentioned above may also be provided as a computer program product (791, 991), for instance in the form of a data carrier carrying computer program code (792, 992) for performing the embodiments herein when being loaded into the network node 511 and the wireless communication device 540. One such carrier may be in the form of a CD ROM disc. It is however feasible with other data carriers such as a memory stick. The computer program code may furthermore be provided as pure program code on a server and downloaded to the network node 511 and the wireless communication device 540.

Thus, the methods according to the embodiments described herein for the network node 511 and the wireless communication device 540 may be implemented by means of a computer program product, comprising instructions, i.e., software code portions, which, when executed on at least one processor, cause the at least one processor to carry out the actions described herein, as performed by the network node 511 and the wireless communication device 540. The computer program product may be stored on a computer-readable storage medium. The computer-readable storage medium, having stored there on the computer program, may comprise the instructions which, when executed on at least one processor, cause the at least one processor to carry out the actions described herein, as performed by the network node 511 and the wireless communication device 540. In some embodiments, the computer-readable storage medium may be a non-transitory computer-readable storage medium.

The wireless communication device 540 and the network node 511 may further each comprise a memory 790, 990, comprising one or more memory units. The memory 790, 990 is arranged to be used to store obtained information such as cell indices, TAG indices, bitmaps, thresholds for transmission timing differences, configurations regarding sending reports when UL transmission has stopped in a cell and applications etc. to perform the methods herein when being executed in the network node 511, and the wireless communication device 540.

Those skilled in the art will also appreciate that the different modules described above may refer to a combination of analog and digital circuits, and/or one or more processors configured with software and/or firmware, e.g. stored in the memory, that when executed by the one or more processors, such as the processors in the network node 511 and the wireless communication device 540 perform as described above. One or more of these processors, as well as the other digital hardware, may be included in a single application-specific integrated circuitry (ASIC), or several processors and various digital hardware may be distributed among several separate components, whether individually packaged or assembled into a system-on-a-chip (SoC).

In embodiments herein a new MAC control element is used by the wireless device 540, such as a UE, to indicate to the wireless communications network 500, i.e. to the network node 511, such as an eNB, that the wireless device 540 has stopped UL transmissions on one or more serving cells and/or TA groups.

According to some first aspect of embodiments herein it is provided a method in the wireless communication device 540, such as a UE, for handling UL transmission in the wireless communications network 500. The wireless communications network 500 comprises at least the first network node 511 which communicates with the wireless communication device 540. The wireless communication device 540 is served by a cell 521 or group of cells 530. The group of cells 530 may be grouped in a TAG. The wireless communication device 540 transmits a report to the network node 511 when the wireless communication device has stopped an UL transmission in the cell 521 or the group of cells 530, e.g. the TAG. The report comprises a control element, such as a MAC control element, indicating that the wireless communication device 540 has stopped the UL transmission in the cell 521 or the group of cells 530, e.g. the TAG.

The wireless communication device 540 may further indicate the cell 521 or the group of cells 530, e.g. the TAG(s), for which the wireless communication device 540 has stopped UL in.

The wireless communication device 540 may indicate that the wireless communication device 540 has stopped UL transmissions without indicating in which cells or which TAGs the UL transmissions has stopped.

According to a second aspect of embodiments herein it is provided a method in a network node 511 for handling UL transmission in a wireless communications network 500. The wireless communications network 500 comprises the network node 511 which communicates with a wireless communication device 540, such as a UE. The wireless communication device 540 is served by a cell 521 or group of cells 530, which group of cells 530 may be grouped in a TAG. The network node 511 receives a report from the wireless communication device 540. The report comprises a control element, such as a MAC control element, indicating that the wireless communication device 540 has stopped the UL transmission in the cell 521 or group of cells 530, e.g. the TAG.

The network node 511 determines which cells or group of cells the wireless communication device 540 has stopped transmitting on based on the report. The determination may be based on the MAC control element.

In response to determining which cells or group of cells the wireless communication device has stopped UL transmission on, the network node 511 may in one or other way limit the resources available for the wireless communication device 540 in the cell 521, or group of cells 530 in which the wireless communication device 540 has stopped UL transmission. Appropriate actions may comprise: stop scheduling the wireless communication device 540 and/or deactivating serving cells in which the wireless communication device 540 has stopped UL, and/or de-configuring the UL part of those serving cells, or completely de-configuring, i.e. both UL and DL, of those serving cells.

When using the word “comprise” or “comprising” it shall be interpreted as non-limiting, i.e. meaning “consist at least of”.

The embodiments herein are not limited to the above described preferred embodiments. Various alternatives, modifications and equivalents may be used. Therefore, the above embodiments should not be taken as limiting the scope.

Although specific terms may be employed herein, they are used in a generic and descriptive sense only and not for purposes of limitation.

Therefore, the above embodiments should not be taken as limiting the scope, which is defined by the appending claims.

Note that although terminology from 3GPP LTE/SAE has been used in this disclosure to exemplify the embodiments herein, this should not be seen as limiting the scope of the embodiments herein to only the aforementioned system. Other wireless systems may also benefit from exploiting the ideas covered within this disclosure.

Also note that terminology such as a first network node and a second network node should be considered to be non-limiting and does in particular not imply a certain hierarchical relation between the two.

1-45. (canceled)

46. A method performed by a wireless communication device for handling uplink transmission in a wireless communications network, which wireless communications network comprises one or more serving cells serving the wireless communication device and further comprises at least a first network node associated with at least one serving cell out of the one or more serving cells, the method comprising:
stopping uplink transmission in a first serving cell out of the one or more serving cells; and
transmitting a report to the first network node, which report comprises a Medium Access Control (MAC) control element, which MAC control element indicates that the wireless communication device has stopped uplink transmission in at least one serving cell out of the one or more serving cells.

47. The method according to claim 46, wherein the MAC control element further indicates:
the first serving cell in which the wireless communication device has stopped uplink transmission, or
when the first serving cell is comprised in a group of cells,
the group of cells in which the wireless communication device has stopped uplink transmission.

48. The method according to claim 47, wherein the first serving cell in which the wireless communication device has stopped uplink transmission is indicated by a bitmap and wherein a field in the bitmap is mapped to the first serving cell or to the group of cells.

49. The method according to claim 48, wherein the field in the bitmap is mapped to an index, which index corresponds to the first serving cell or to the group of cells, and wherein the mapping to the index is based on the position of the field in the bitmap.

50. The method according to claim 47, wherein the group of cells is a Timing Advance Group (TAG) and wherein the MAC control element indicates the TAG in which the wireless communication device has stopped uplink transmission.

51. The method according to claim 46, further comprising:
transmitting the report to a second network node associated with at least one serving cell out of the one or more serving cells.

52. The method according to claim 51, wherein the report further indicates which network node that is associated with the first serving cell and/or the group of cells in which the wireless communication device has stopped uplink transmission.

53. The method according to claim 46, wherein a second network node is associated with at least one serving cell out of the one or more serving cells, and wherein the first network node is associated with the first serving cell in which the wireless communication device has stopped uplink transmission, and wherein the method includes transmitting the report only to the first network node.

54. The method according to claim 46, wherein the first serving cell in which the wireless communication device has stopped uplink transmission is associated with a second network node.

55. The method according to claim 46, wherein two or more groups of fields are comprised in a bitmap comprising the MAC control element, and wherein a first group of field is associated with the first network node and a second group of field is associated with the second network node.

56. The method according to claim 46, wherein
the wireless communication network is an Long Term Evolution, LTE, network;
the network nodes are evolved NodeBs;
the wireless communication device is a User Equipment, UE; and
the report is transmitted with MAC signaling.

57. A wireless communication device configured to handle uplink transmission in a wireless communications network, which wireless communications network comprises one or more serving cells serving the wireless communication device and further comprises at least a first network node associated with at least one serving cell out of the one or more serving cells, the wireless communication device is configured to:
stop uplink transmission in a first serving cell out of the one or more serving cells; and
transmit a report to the first network node in response to stopping uplink transmission in the first serving cell, which report comprises a Medium Access Control (MAC) control element, which MAC control element indicates that the wireless communication device has stopped uplink transmission in at least one serving cell out of the one or more serving cells.

58. The wireless communication device according to claim 57, wherein the MAC control element further indicates:
the first serving cell in which the wireless communication device has stopped uplink transmission, or
when the first serving cell is comprised in a group of cells,
the group of cells in which the wireless communication device has stopped uplink transmission.

59. The wireless communication device according to claim 58, wherein the report further indicates which network node that is associated with the first serving cell and/or the group of cells in which the wireless communication device has stopped uplink transmission in.

60. The wireless communication device according to claim 58, wherein the first serving cell in which the wireless communication device has stopped uplink transmission is indicated by a bitmap and wherein a field in the bitmap is mapped to the first serving cell or to the group of cells.

61. The wireless communication device according to claim 60, wherein the field in the bitmap is mapped to an index, which index corresponds to the first serving cell or to the group of cells, and wherein the mapping to the index is based on the position of the field in the bitmap.

62. The wireless communication device according to claim 58, wherein the group of cells is a Timing Advance Group (TAG) and wherein the MAC control element indicates the TAG in which the wireless communication device has stopped uplink transmission.

63. The wireless communication device according to claim 57, wherein the wireless communication device is further configured to:
transmit the report to a second network node associated with at least one serving cell out of the one or more serving cells.

64. The wireless communication device according to claim 57, wherein a second network node is associated with at least one serving cell out of the one or more serving cells, and wherein the first network node is associated with the first serving cell in which the wireless communication device has stopped uplink transmission, and wherein the wireless communication device is configured to transmit the report only to the first network node.

65. The wireless communication device according to claim 57, wherein the first serving cell in which the wireless communication device has stopped uplink transmission is associated with a second network node.

66. The wireless communication device according to claim 65, wherein two or more groups of fields are comprised in a bitmap comprising the MAC control element, and wherein a first group of field is associated with the first network node and a second group of field is associated with the second network node.

67. The wireless communication device according to claim 57, wherein
the wireless communication network is an Long Term Evolution (LTE) network;
the network nodes are evolved NodeBs;
the wireless communication device is a User Equipment (UE); and
the report is transmitted with MAC signaling.

68. A method performed by a first network node for handling uplink transmission in a wireless communications network, which wireless communications network comprises one or more serving cells serving the wireless communication device and further comprises at least the first network node associated with at least one serving cell out of the one or more serving cells, the method comprising:
receiving a report from the wireless communication device, which report comprises a Medium Access Control (MAC) control element, which MAC control element indicates that the wireless communication device has stopped the uplink transmission in at least one serving cell out of the one or more serving cells, and
determining in which cell the wireless communication device has stopped the uplink transmission, based on the report.

69. The method according to claim 68, wherein the MAC control element further indicates:
the first serving cell in which the wireless communication device has stopped uplink transmission, or
when the first serving cell is comprised in a group of cells,
the group of cells in which the wireless communication device has stopped uplink transmission; and
wherein determining in which cell the wireless communication device has stopped the uplink transmission is based on the MAC control element.

70. The method according to claim 69, wherein the first serving cell in which the wireless communication device has stopped uplink transmission is indicated by a bitmap and wherein a field in the bitmap is mapped to the first serving cell, or to the group of cells, in which the wireless communication device has stopped uplink transmission.

71. The method according to claim 69, wherein the group of cells is a Timing Advance Group (TAG) and wherein the MAC control element indicates the TAG in which the wireless communication device has stopped uplink transmission.

72. The method according to claim 68, further comprising limiting the resources available for the wireless communication device in the first serving cell in which the wireless communication device has stopped uplink transmission, in response to determining in which cell the wireless communication device has stopped uplink transmission.

73. The method according to claim 72, wherein limiting the resources comprises any one or more out of:
stopping scheduling the wireless communication device in the first serving cell in which the wireless communication device has stopped the uplink transmission; and
deactivating the first serving cell in which the wireless communication device has stopped uplink transmission; and
de-configuring any one or more out of the uplink part of the first serving cell in which the wireless communication device has stopped uplink transmission, and the downlink part of the first serving cell in which the wireless communication device has stopped uplink transmission.

74. The method according to claim 68, wherein the first network node is associated with the first serving cell in which the wireless communication device has stopped uplink transmission.

75. The method according to claim 68, wherein the first serving cell in which the wireless communication device has stopped uplink transmission is associated with a second network node.

76. The method according to claim 68, wherein
the wireless communication network is an Long Term Evolution (LTE) network;
the network nodes are evolved NodeBs;
the wireless communication device is a User Equipment (UE); and
the report is transmitted with MAC signaling.

77. A first network node configured to handle uplink transmission in a wireless communications network, which wireless communications network comprises one or more serving cells serving a wireless communication device, and further comprises at least the first network node associated with at least one serving cell out of the one or more serving cells, the first network node is configured to:
receive a report from the wireless communication device, which report comprises a Medium Access Control (MAC) control element, which MAC control element indicates that the wireless communication device has stopped the uplink transmission in a first serving cell out of the one or more serving cells, and
determine in which cell the wireless communication device has stopped the uplink transmission based on the report.

78. The first network node according to claim 77, wherein the MAC control element further indicates:
the first serving cell in which the wireless communication device has stopped uplink transmission, or
when the first serving cell is comprised in a group of cells,
the group of cells in which the wireless communication device has stopped uplink transmission; and
wherein the network node is further configured to determine in which cell the wireless communication device has stopped the uplink transmission based on the MAC control element.

79. The first network node according to claim 78, wherein the first serving cell in which the wireless communication device has stopped uplink transmission is indicated by a bitmap and wherein a field in the bitmap is mapped to the first serving cell, or to the group of cells, in which the wireless communication device has stopped uplink transmission.

80. The first network node according to claim 78, wherein the group of cells is a Timing Advance Group (TAG) and wherein the MAC control element indicates the TAG in which the wireless communication device has stopped uplink transmission.

81. The first network node according to claim 77, further configured to limit the resources available for the wireless communication device in the first serving cell in which the wireless communication device has stopped uplink transmission, in response to having determined in which cell the wireless communication device has stopped uplink transmission.

82. The first network node according to claim 81, wherein first network node is configured to limit the resources available for the wireless communication device in the first serving cell in which the wireless communication device has stopped transmitting by being configured to perform any one or more out of:
stop scheduling the wireless communication device in the first serving cell in which the wireless communication device has stopped the uplink transmission; and
deactivate the first serving cell in which the wireless communication device has stopped uplink transmission; and
de-configure any one or more out of the uplink part of the first serving cell in which the wireless communication device has stopped uplink transmission, and the downlink part of the first serving cell in which the wireless communication device has stopped uplink transmission.

83. The first network node according to claim 77, wherein the first network node is configured to serve the first serving cell in which the wireless communication device has stopped uplink transmission.

84. The first network node according to claim 77, wherein the first serving cell in which the wireless communication device has stopped uplink transmission is associated with a second network node.

85. The first network node according to claim 77, wherein
the wireless communication network is an Long Term Evolution (LTE) network;
the network nodes are evolved NodeBs;
the wireless communication device is a User Equipment (UE); and
the report is transmitted with MAC signaling.

86. A wireless communication device for handling uplink transmission in a wireless communications network, which wireless communications network comprises one or more serving cells serving the wireless communication device and further comprises at least a first network node associated with at least one serving cell out of the one or more serving cells, which wireless communication device comprises a processor and a memory, said memory containing instructions executable by said processor whereby said wireless communication device is operative to:
stop uplink transmission in a first serving cell out of the one or more serving cells; and
transmit a report to the first network node in response to stopping uplink transmission in the first serving cell, which report comprises a Medium Access Control (MAC) control element, which MAC control element indicates that the wireless communication device has stopped uplink transmission in at least one serving cell out of the one or more serving cells.

87. A first network node for handling uplink transmission in a wireless communications network, which wireless communications network comprises one or more serving cells serving a wireless communication device, and further comprises at least the first network node associated with at least one serving cell out of the one or more serving cells, which first network node comprises a processor and a memory, said memory containing instructions executable by said processor whereby said first network node is operative to:
receive a report from the wireless communication device, which report comprises a Medium Access Control (MAC) control element, which MAC control element indicates that the wireless communication device has stopped the uplink transmission in a first serving cell out of the one or more serving cells, and
determine in which cell the wireless communication device has stopped the uplink transmission based on the report.

88. A wireless communication device for handling uplink transmission in a wireless communications network, which wireless communications network comprises one or more serving cells serving the wireless communication device and further comprises at least a first network node associated with at least one serving cell out of the one or more serving cells, which wireless communication device comprises:
a stopping module configured to stop uplink transmission in a first serving cell out of the one or more serving cells; and
a transmitting module configured to transmit a report to the first network node in response to stopping uplink transmission in the first serving cell, which report comprises a Medium Access Control, MAC, control element, which MAC control element indicates that the wireless communication device has stopped uplink transmission in at least one serving cell out of the one or more serving cells.

89. A first network node for handling uplink transmission in a wireless communications network, which wireless communications network comprises one or more serving cells serving a wireless communication device, and further comprises at least the first network node associated with at least one serving cell out of the one or more serving cells, which first network node comprises:
a receiving module configured to receive a report from the wireless communication device, which report comprises a Medium Access Control, MAC, control element, which MAC control element indicates that the wireless communication device has stopped the uplink transmission in a first serving cell out of the one or more serving cells, and
a determining module configured to determine in which cell the wireless communication device has stopped the uplink transmission based on the report.
